(19) United States
(12) Patent Application Publication
(10) Pub. No.: US 2023/0364627 A1
(43) Pub. Date: Nov. 16, 2023

(54) SHOWERHEAD

(71) Applicant: Kohler Co., Kohler, WI (US)

(72) Inventors: Hiroyuki Chanseol Muraoka, New York, NY (US); James Bourne, Cheltenham (GB)

(73) Assignee: Kohler Co., Kohler, WI (US)

(21) Appl. No.: 18/315,924

(22) Filed: May 11, 2023

Related U.S. Application Data
(60) Provisional application No. 63/341,288, filed on May 12, 2022.
(60) Provisional application No. 63/435,098, filed on Dec. 23, 2022.

(51) Int. Cl. B05B 1/26; F21V 33/00; F21S 9/04; H04R 1/02; H04R 3/00

(52) U.S. Cl. CPC B05B 1/265; F21V 33/006; F21S 9/046; H04R 1/028; H04R 3/00

(57) ABSTRACT

An exemplary embodiment relates to a showerhead for use in a shower environment. The showerhead includes a plurality of replaceable covering panels, at least one integrated light, and at least one integrated speaker that is configured to emit music. The showerhead also includes a central showerhead and a separate structure external to the central showerhead. The central showerhead and the separate structure are configured to emit water in a plurality of spray patterns. The showerhead is also configured to emit the light, music, and water simultaneously.

### CROSS-REFERENCE TO RELATED PATENT APPLICATIONS

This application claims the benefit of and priority to U.S. Provisional Patent Application No. 63/341,288, filed May 12, 2022, and U.S. Provisional Patent Application No. 63/435,098, filed Dec. 23, 2022, both of which are incorporated herein by reference in their entireties.

### BACKGROUND

The present disclosure relates generally to showerheads. More specifically, the present disclosure relates to showerheads that include a unique structural configuration that provides sprays at multiple levels, provides a unique changeable aesthetic, and that may include light, sound, or other features.

Such showerheads may include features for providing ambient lighting in showers and/or for providing information or indications relating to the showering experience such as the duration of the shower, the temperature of the water in the shower, and/or other information that a user may find useful.

Many residential spaces (e.g., homes, condos, apartments, hotels, motels, etc.) have showers. Often times, showers may be located in a space that is not well lit. For instance, where a home has a shower having a shower curtain, the shower may not be lit with ambient lighting or with a lighting fixture positioned within the showering enclosure for providing additional light for a user. When constructing a bathroom, some homeowners may install lighting within the shower space, such as recessed lighting, for instance. However, installing lighting in the shower space after a bathroom has already been constructed can be difficult and costly.

It would be advantageous to provide a showerhead that addresses one or more of the aforementioned issues.

### SUMMARY

An exemplary embodiment relates to a showerhead that includes a first spray mechanism comprising a first plurality of nozzles and at least one lighting element; a second spray mechanism separate from and located a distance away from the first spray mechanism; and a surrounding structure comprising a plurality of members extending between the first spray mechanism and the second spray mechanism such that the first spray mechanism is at least partially surrounded by the surrounding structure.

Another exemplary embodiment relates to a shower assembly that includes a first sprayhead; a second sprayhead separate from the first sprayhead; a plurality of replaceable fins extending between the first and second sprayhead and defining a structure that at least partially surrounds the first sprayhead; at least one lighting element; and at least one speaker.

Another exemplary embodiment relates to a method of assembling a showerhead, the method comprising: placing a first shade mount and a second shade mount onto a jig; inserting a covering panel into the first shade mount by rolling a first end of the covering panel into a slot in the first shade mount; inserting a covering panel into the second shade mount by inserting a second end of the covering panel into a slot in the second shade mount; inserting a plurality of covering panels into the first shade mount and the second shade mount to form the overall shape of the showerhead; and fastening an upper portion of the second shade mount to a lower portion of the second shade mount using a fastener.

Another exemplary embodiment relates to a showerhead for use in a shower environment. The showerhead includes a plurality of replaceable covering panels, at least one integrated light, and at least one integrated speaker that is configured to emit music. The showerhead also includes a central showerhead and a separate structure external to the central showerhead. The central showerhead and the separate structure are configured to emit water in a plurality of spray patterns. The showerhead is also configured to emit the light, music, and water simultaneously.

Another embodiment relates to a shower assembly for use in a shower environment. The shower assembly includes a showerhead that includes a plurality of replaceable covering panels that form the overall shape of the showerhead. The showerhead also includes at least one integrated light where the light is emitted through a diffuser. The showerhead also includes at least one integrated speaker that is configured to emit music. The showerhead also includes a central showerhead and a separate structure external to the central showerhead where the separate structure is configured to be in a ring shape. The central showerhead and the separate structure are configured to emit water in a plurality of spray patterns. The shower assembly also includes a control unit operably coupled to the showerhead. The control unit is configured to control the light, the speaker, and the water simultaneously.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a front view of a showerhead, according to an exemplary embodiment.

FIG. 2 is a partial exploded view of the showerhead of FIG. 1, according to an exemplary embodiment.

FIG. 3 is a partial exploded view of another showerhead, according to an exemplary embodiment.

FIG. 4 is a perspective view of an internal spray system of the showerhead of FIG. 3, according to an exemplary embodiment.

FIG. 5 is a perspective view of a rim spray of the showerhead of FIG. 3, according to an exemplary embodiment.

FIG. 6 is a perspective view of another showerhead, according to an exemplary embodiment.

FIG. 7 is a detailed view of the internal spray system of FIG. 4, according to an exemplary embodiment;

FIG. 8 is a schematic diagram of a control system for the internal spray system of FIG. 4, according to an exemplary embodiment;

FIGS. 9-27 are side views of other implementations of a showerhead, according to various exemplary embodiments.

FIG. 28 is a front view of a controller for use in any of the showerheads illustrated or described herein, according to an exemplary embodiment.

FIG. 29 is a schematic diagram of a control system for use in any of the showerheads illustrated or described herein, according to an exemplary embodiment.

FIG. 30 is a flow diagram of a method of controlling the showerhead illustrated in any of the showerheads illustrated or described herein, according to an exemplary embodiment.

FIGS. 31-42 are front views of other designs for showerheads, according to various exemplary embodiments.

FIG. 43 is a perspective view of a portion of another showerhead, according to an exemplary embodiment.

FIG. 44 is another perspective view of the portion of the showerhead shown in FIG. 43, according to an exemplary embodiment.

FIG. 45A is a perspective view of the showerhead of FIG. 43 being placed on a jig at a first step of assembling the covering panels, according to an exemplary embodiment.

FIG. 45B is a perspective view of the showerhead of FIG. 43 placed on a jig at a first step of assembling the covering panels, according to an exemplary embodiment.

FIG. 46A is a perspective view of the showerhead of FIG. 43 placed on a jig at a second step of assembling the covering panels, according to an exemplary embodiment.

FIG. 46B is a detailed view of the insertion of a covering panel into the showerhead of FIG. 43 at a second step of assembling the covering panels, according to an exemplary embodiment.

FIG. 47A is a perspective view of the showerhead of FIG. 43 placed on a jig at a second step of assembling the covering panels, according to an exemplary embodiment.

FIG. 47B is a detailed view of the insertion of a covering panel into the showerhead of FIG. 43 at a second step of assembling the covering panels, according to an exemplary embodiment.

FIG. 48A is a perspective view of the showerhead of FIG. 43 placed on a jig at a third step of assembling the covering panels, according to an exemplary embodiment.

FIG. 48B is a detailed view of the insertion of a covering panel into the showerhead of FIG. 43 at a third step of assembling the covering panels, according to an exemplary embodiment.

FIG. 48C is a detailed view of the insertion of a covering panel into the showerhead of FIG. 43 at a third step of assembling the covering panels, according to an exemplary embodiment.

FIG. 49 is a perspective view of the showerhead of FIG. 43 placed on a jig at a fourth step of assembling the covering panels, according to an exemplary embodiment.

FIG. 50A is a perspective view of the showerhead of FIG. 43 placed on a jig at a fifth step of assembling the covering panels, according to an exemplary embodiment.

FIG. 50B is a detailed view of fastening a rim assembly of the showerhead of FIG. 43 at a fifth step of assembling the covering panels, according to an exemplary embodiment.

FIG. 51 is a perspective view of another showerhead, according to an exemplary embodiment.

FIG. 52 is another perspective view of the showerhead of FIG. 51, according to an exemplary embodiment.

FIG. 53 is an exploded view of the showerhead of FIG. 51, according to an exemplary embodiment.

FIG. 54 is a detailed view of a portion of the showerhead of FIG. 51, according to an exemplary embodiment.

FIG. 55A is a perspective view of a portion of the showerhead of FIG. 51, according to an exemplary embodiment.

FIG. 55B is a detailed view of a portion of the showerhead of FIG. 51, according to an exemplary embodiment.

FIG. 55C is a perspective view of a portion of the showerhead of FIG. 51, according to an exemplary embodiment.

FIG. 55D is a detailed view of a portion of the showerhead of FIG. 51, according to an exemplary embodiment.

FIG. 56A is a perspective view of a portion of a showerhead, according to an exemplary embodiment.

FIG. 56B is a perspective view of the portion of a showerhead of FIG. 56A, according to an exemplary embodiment.

FIG. 57A is a perspective view of a portion of a showerhead, according to an exemplary embodiment.

FIG. 57B is a detailed view of a portion of a showerhead, according to an exemplary embodiment.

FIG. 57C is a perspective view of a portion of a showerhead, according to an exemplary embodiment.

FIG. 58A is a perspective view of a portion of a showerhead, according to an exemplary embodiment.

FIG. 58B is a detailed view of a portion of a showerhead, according to an exemplary embodiment.

FIG. 58C is a perspective view of a portion of a showerhead, according to an exemplary embodiment.

FIG. 59A is a detailed view of a portion of a showerhead, according to an exemplary embodiment.

FIG. 59B is a perspective view of a portion of the showerhead of FIG. 51, according to an exemplary embodiment.

FIG. 60 is a perspective view of a portion of the showerhead of FIG. 51, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a showerhead includes a first spray mechanism (e.g., a sprayhead), a second spray mechanism (e.g., a sprayhead), and a surrounding structure to provide at least a portion of an overall aesthetic (e.g., profile, shape, etc.) for the showerhead. In some embodiments, the first spray mechanism is a sprayhead positioned internal to the surrounding structure, and may optionally include one or more lighting elements and/or one or more speaker elements. In some embodiments, the second spray mechanism may optionally include one or more lighting elements. A hose, pipe, or tube may extend between the first and second spray mechanisms to provide water from one to the other. In some embodiments, the surrounding structure may include one or more permanent or replaceable elements that have sizes, shapes, and configurations intended to provide an overall aesthetic for the showerhead. In some cases, such members may be radially-oriented fins or ribs that extend between the first and second spray mechanisms (e.g., where such members may be coupled or mounted to one or both of the first and second spray mechanisms or to other components coupled directly or indirectly to the first and second spray mechanisms, such that the members extend from a location proximate the first spray mechanism to a location proximate the second spray mechanism), although it should be understood that other configurations are also possible. In some embodiments, the permanent or replaceable members may partially or totally conceal one or both of the first and second spray mechanisms. In some embodiment, the showerhead may be configured to allow the synchronized delivery of two or more of water, sound (e.g., music), and lighting.

According to an exemplary embodiment, a showerhead or shower device includes an internal or central spray head and a structure external to the internal spray head that provides a unique overall external aesthetic for the showerhead. For example, the showerhead may include a plurality of permanent or replaceable members or elements (e.g., fins, ribs, covering panels, etc.) that are arranged around the spray head to provide an overall aesthetic appearance for the showerhead. In some embodiments, the permanent or replaceable members may be radially-oriented ribs or fins that may either be permanently affixed to the showerhead or may be removable and replaceable with other types of ribs or fins to change the overall appearance of the showerhead as desired. For ease of reference throughout the following description, the permanent or replaceable members will be referred to as “fins,” although it should be understood by those reviewing the present application that such members may have a wide variety of configurations other than those shown herein.

According to some embodiments, the external structure may be formed at least partially of components having a translucent or transparent material to allow light to travel therethrough. Such embodiments may allow for light of different colors and durations to be used to provide a lighting experience to a user of the showerhead.

Referring generally to the FIGURES, according to one exemplary embodiment, the showerhead includes a first spray mechanism shown as an internal or central spray system (e.g., a first sprayhead) and second spray mechanism shown as a rim or ring spray (e.g., a second sprayhead). For ease of reference, the first spray mechanism may be referred to as an internal spray system and the second spray mechanism may be referred to as a rim spray, although it should be understood that configurations other than those shown in the accompanying drawings are possible according to various exemplary embodiments. The internal spray system may be fluidly coupled to the showerhead via a first water supply line. The internal spray system may include a first plurality of nozzles, a light, a speaker, and a control unit operably coupled to the light and the speaker. The rim spray may include a second plurality of nozzles. The control unit further receives a first programmed command to sequentially change a condition of a spray mode outputted from the first plurality of nozzles and the second plurality of nozzles based on the first programmed command. The control unit further receives a second programmed command to sequentially change a condition of the light based on the second programmed command. In some embodiments, the spray mode transitions based on a first pre-programmed command. In some embodiments, a light condition transitions based on a second pre-programmed command.

According to an exemplary embodiment, the first spray mechanism and second spray mechanism may be provided at different levels. For example, where the showerhead is oriented such that the central longitudinal axis of the showerhead is oriented vertically, the first spray mechanism may be located at a height that is greater than the height of the second spray mechanism.

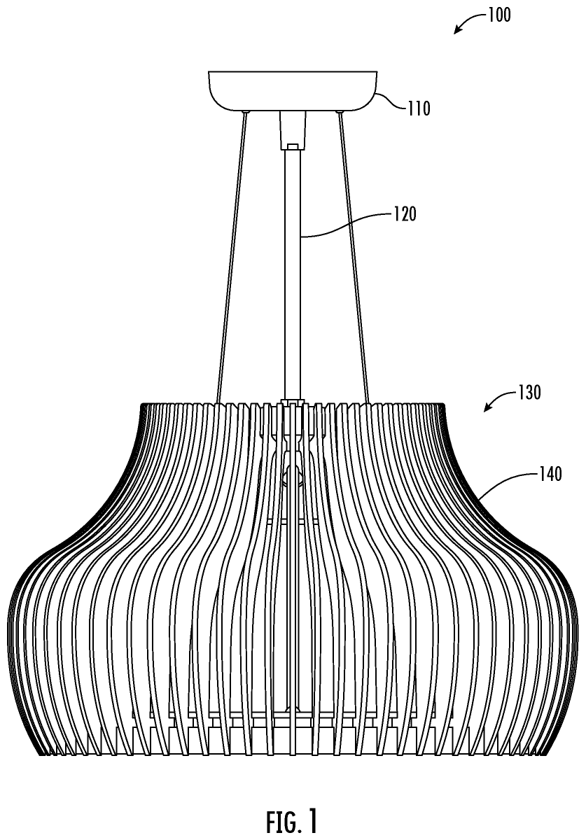

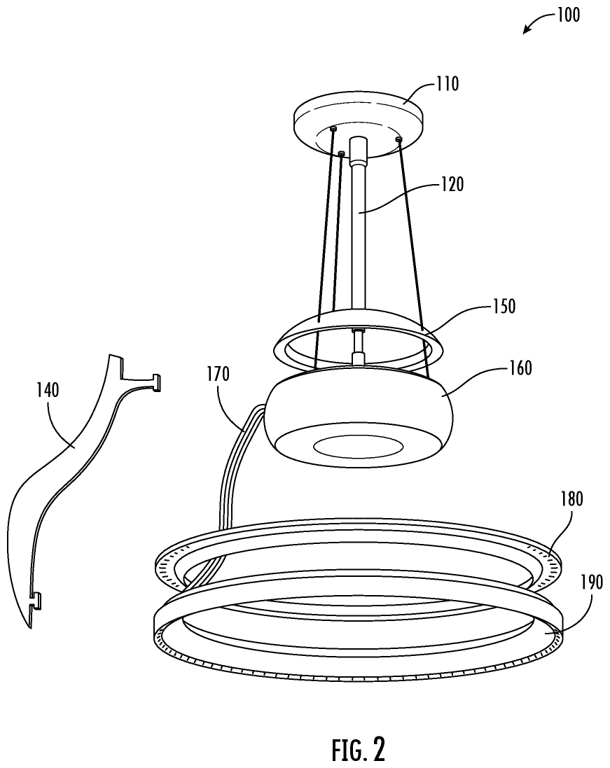

Referring to FIGS. 1 and 2, a showerhead 100 is shown according to an exemplary embodiment. The showerhead 100 may be installed in a showering environment within a bathroom or elsewhere. The showerhead 100 may be a ceiling hanging showerhead according to an exemplary embodiment, although it should be understood that in some configurations, the showerhead may be mounted such that a water supply pipe for the showerhead may instead extend from another wall (e.g., a vertical wall), and that the manner of coupling the showerhead to a water supply is a matter of design choice.

The showerhead 100 may include a mounting structure that may include an escutcheon and/or a bracket (collectively referred to herein in the interest of brevity as mounting bracket 110). The mounting bracket 110 may be coupled to the ceiling (or wall, as the case may be), where the mounting bracket 110 may be positioned on an outer surface of the ceiling (or wall). In some embodiments, the mounting bracket 110 may be positioned within the ceiling, where the showerhead 100 extends from the ceiling (or within the wall where the showerhead extends from a wall). The showerhead 100 may include a first water supply 120. The first water supply 120 may extend through the mounting bracket 110, where the first water supply 120 is fluidly coupled to a water source. As can be appreciated, the first water supply 120 may include two ends: one fluidly coupled to the water source and one fluidly coupled to one or more nozzles that are configured to dispense water into the shower environment.

The showerhead 100 may include a structure that fully or partially surrounds an internal spray system 160 (as will be described in greater detail below) to provide a particular overall aesthetic appearance for the showerhead, and which will be referred to herein for ease of reference as a surrounding structure 130 (or, alternatively, as a “covering” structure). The surrounding structure 130 may provide an appearance reminiscent of a lampshade or lighting fixture, and may act to protect and/or to completely or partially obscure or conceal the internal spray system 160. The surrounding structure 130 may include one or more features (e.g., permanent or replaceable members or elements) referred to herein for ease of reference as fins 140 (e.g., “ribs” or “fins”). As illustrated in FIG. 1, the fins 140 may be provided as a plurality of radial fins or ribs that extend outwardly away from an internal spray head. The fins 140 may extend around a side of the surrounding structure 130, where a top and a bottom of the surrounding structure 130 may be open. According to an exemplary embodiment, the fins are configured to extend between or span the distance between the internal spray head and the rim spray. For example, one end or other portion of a fin may be coupled directly or indirectly to the internal spray head and another end or portion of the fin may be coupled directly or indirectly to the rim spray (or to other components that may be coupled directly or indirectly to such sprays). According to other exemplary embodiments, the fins may extend beyond the internal spray head and/or the rim spray (e.g., the upper end of a fin may extend beyond the upper end of the internal spray head and/or the lower end of a fin may extend beyond the lower end of the rim spray).

According to an exemplary embodiment, the fins 140 may be configured for providing a lighting effect. That is, the fins 140 may be configured to shade and/or direct light into the showering or other environment in which the showerhead 100 is provided. The lighting effect from the fins 140 may be controlled by the user to enhance the user experience. According to some embodiments, a user may choose the type of lighting effect based on user preferences.

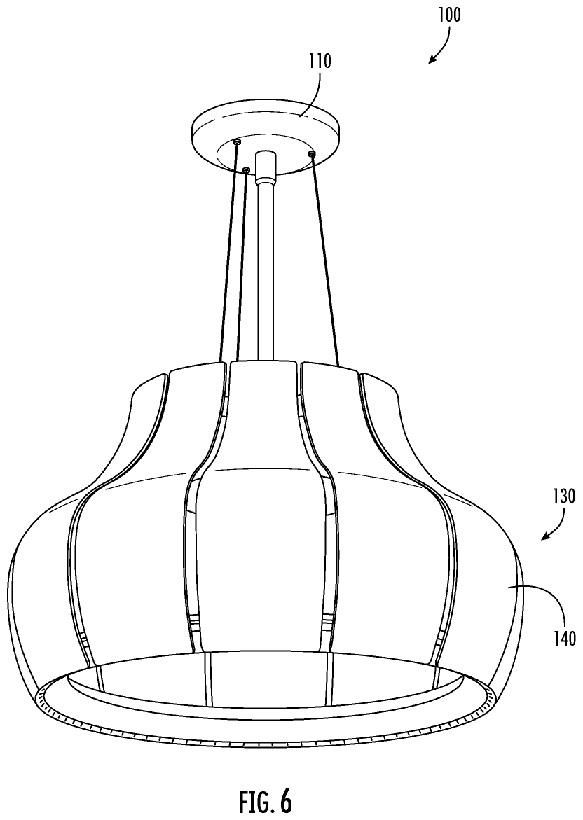

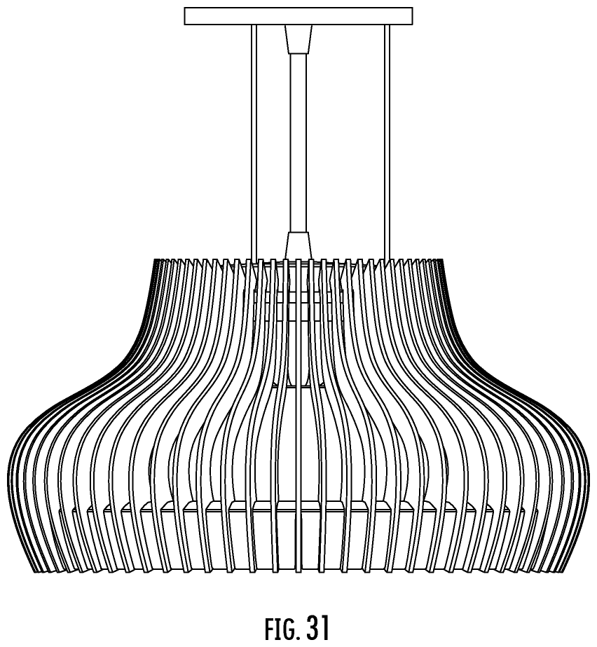

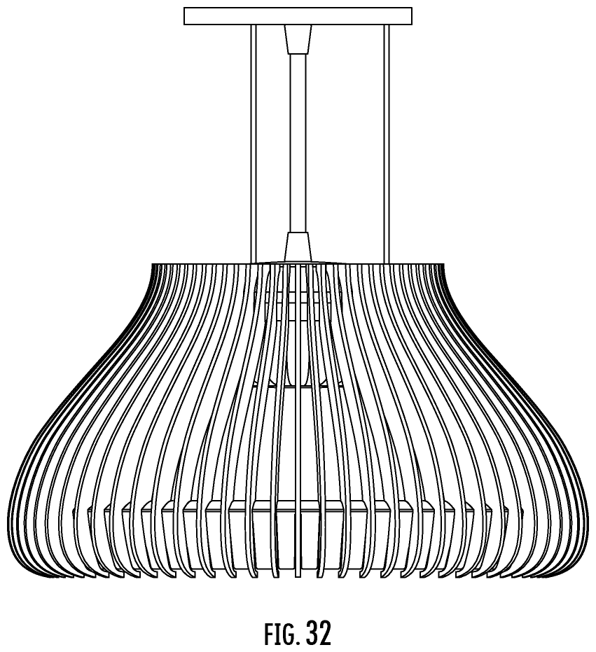

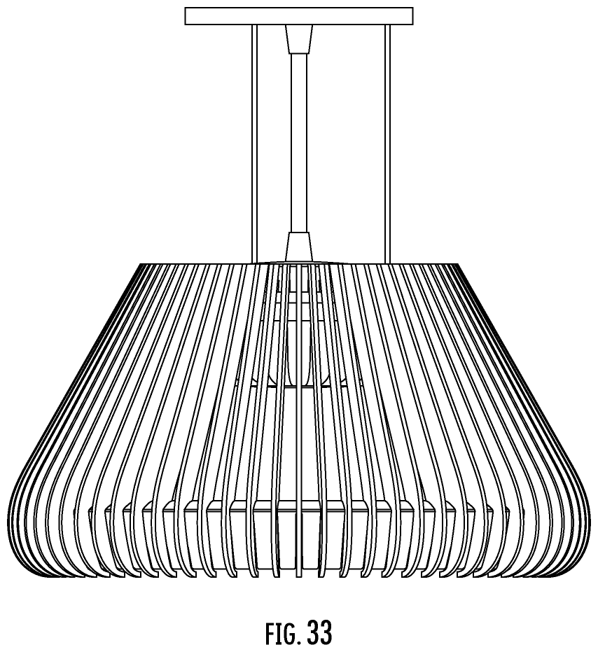

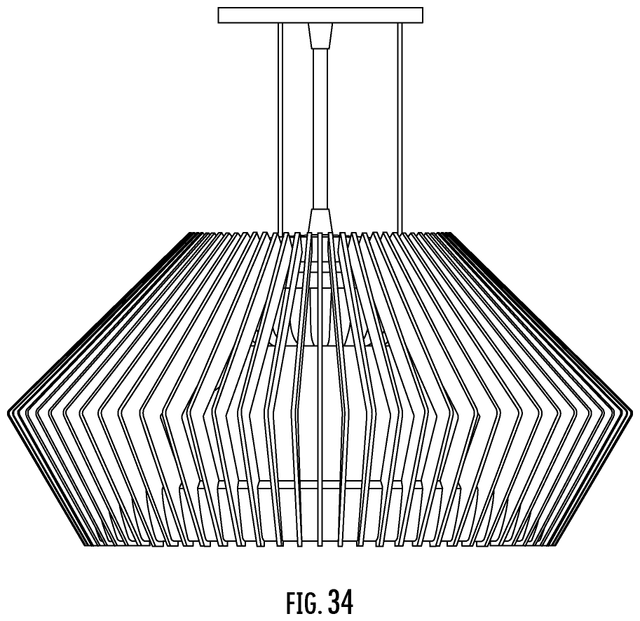

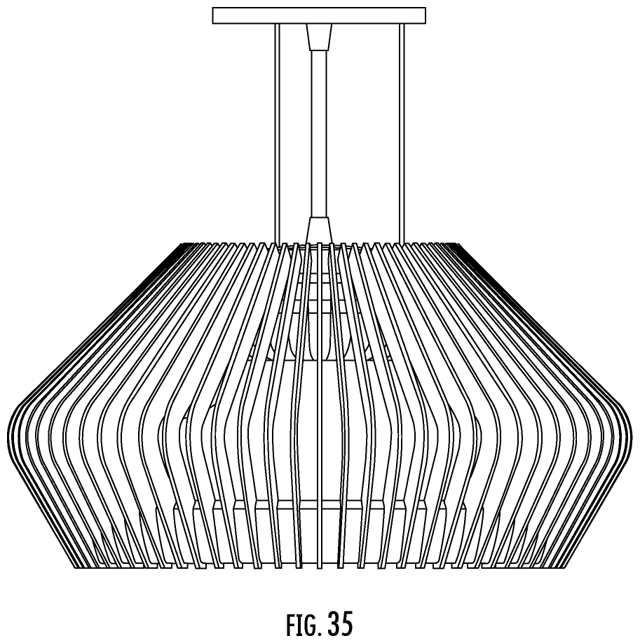

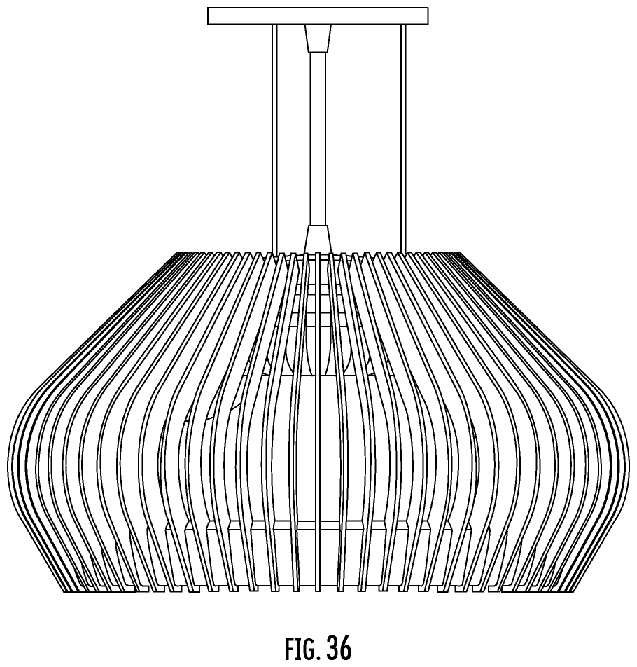

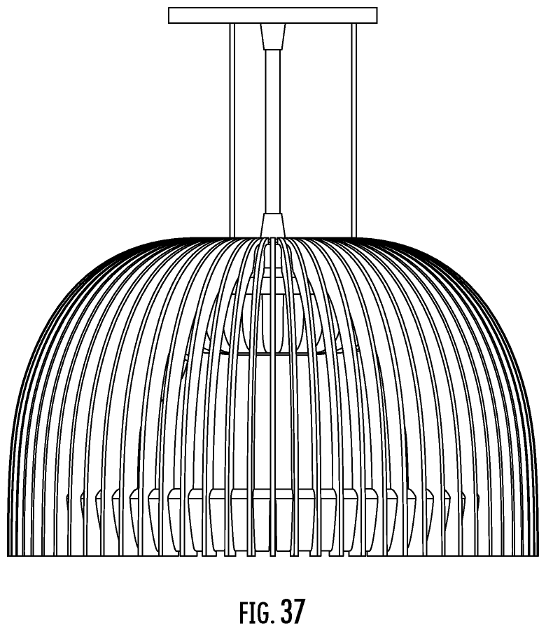

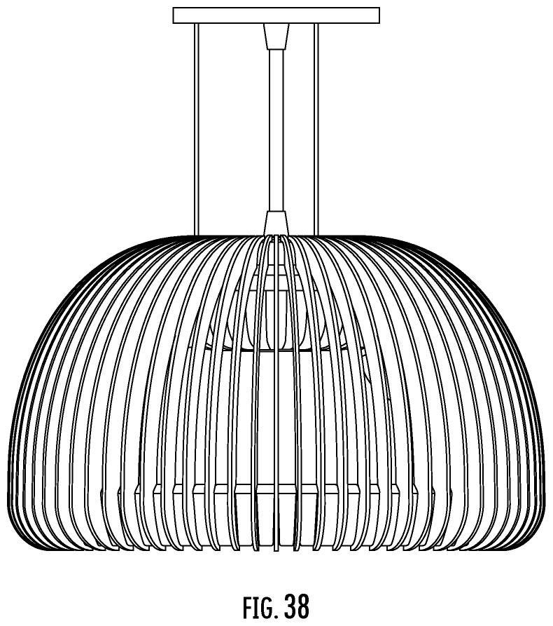

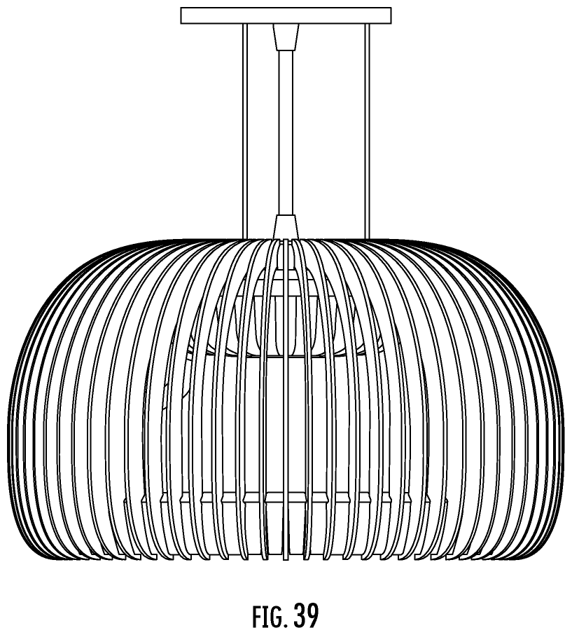

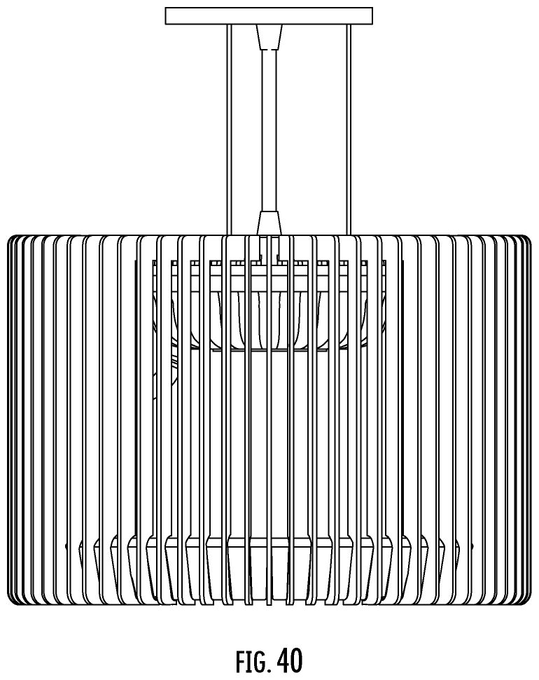

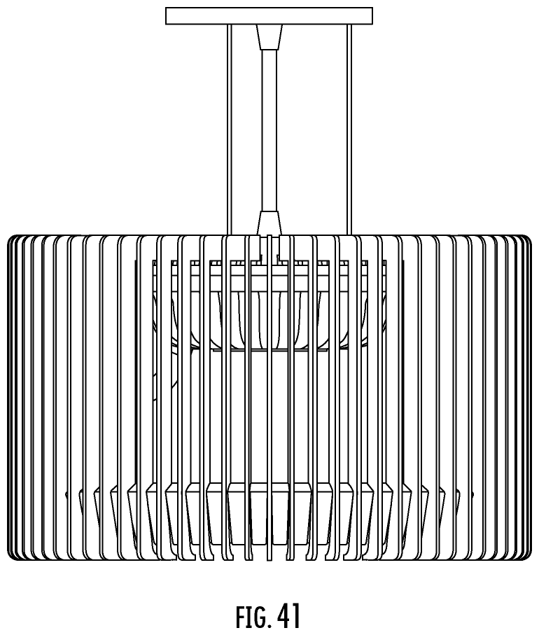

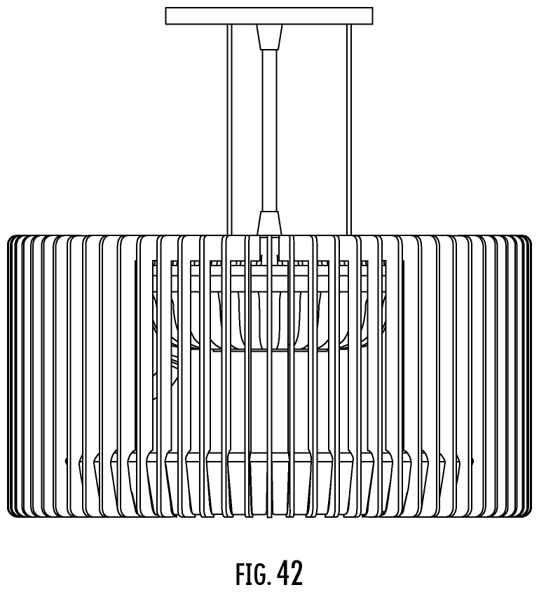

Although the surrounding structure 130 shown in FIG. 1 is shown as having multiple fins 140, the surrounding structure 130 may include a single fin 140. In still other embodiments, the surrounding structure 130 may include no fins 140. For example, as shown in FIG. 6, the fins 140 may be provided in the form of “panels” that are substantially wider than the fins 140 shown in FIG. 1. According to an exemplary embodiment, the surrounding structure 130 may include a total of 72 fins 140, although a different number may be provided in other embodiments (e.g., such shown in FIG. 6). FIGS. 31-39 show other embodiments having different configurations for the fins 140, which may provide a different aesthetic appearance for the showerhead. FIGS. 40-42 show other embodiments where the fins may be a plurality of straight ribs, where the straight ribs may be different lengths. It should be understood that a wide variety of sizes, shapes, and configurations for the fins are possible, and that the embodiments illustrated in the accompany drawing figures are by no means exhaustive.

The fins 140 may be made from a variety of materials. For example, in an exemplary embodiment, the fins 140 may be made from an acrylic material. The acrylic material may have different finishes or colors, including but not limited to translucent mauve, frosted green, rainbow iridescent, clear, or opaque. Acrylic may be advantageous for this design because it may allow light to shine through the material and illuminate the shower to create a lighting effect that may enhance the user experience. In other embodiments, the fins 140 may be made from wood which may have different finishes or colors. Wood may be advantageous to this design because its aesthetic may create a different lighting effect and may enhance the user experience. It should be noted that any of a wide variety of materials may be used for the covering and the fins, including various plastics, woods, glasses, metals, and/or composite materials. Although the showerhead 100 shown in FIG. 1 is shown as having a surrounding structure 130, the showerhead 100 may also be used without a surrounding structure 130.

As shown in FIG. 2, the showerhead 100 may include a member or element referred to herein as a first shade mount 150. The first shade mount 150 may be concentrically provided about the showerhead 100. The first shade mount 150 may include one or more notches, protrusions, fasteners, interfaces, or the like, configured to engage the fins 140. That is, the fins 140 may be coupled to the one or more notches as such to couple the fins 140 to the showerhead 100.

The showerhead 100 may include member or element referred to herein as a second shade mount 180. The second shade mount 180 may be concentrically provided about the showerhead 100. The second shade mount 180 may include one or more notches, protrusions, fasteners, interfaces, or the like, configured to engage the fins 140. That is, the fins 140 may be coupled to the one or more notches as such to couple the fins 140 to the showerhead 100. The shade mounts 150, 180 may cooperatively define a shade mount assembly configured to couple the fins 140 to showerhead 100.

According to an exemplary embodiment the fins 140 may be removable and/or interchangeable. That is, the fins 140 may be removable from the showerhead 100. The fins 140 may be removed from the one or more notches, protrusions, fasteners, interfaces, or the like on the shade mounts 150, 180. It should be noted that while the accompanying figures illustrate particular configurations for such features, it should be understood that other configurations are possible, and that all are intended to be encompassed by the present disclosure. Additionally or alternatively, secondary features such as fasteners may be used to couple the fins to the showerhead structure. The fins 140 may be replaced by fins 140 of similar or different shapes, sizes, materials, or colors, etc. utilizing the one or more notches, protrusions, fasteners, interfaces, or the like on the shade mounts 150, 180. The fins 140 may be removed without being replaced. Although the showerhead 100 in FIG. 2 is shown as including two shades mounts (e.g., shade mounts 150, 180), the showerhead 100 may also include more or less than two shade mounts. For example, the showerhead 100 may not include any shade mounts. In yet another example, the showerhead 100 may include a single shade mount. In yet another example, the showerhead 100 may include three or more shade mounts.

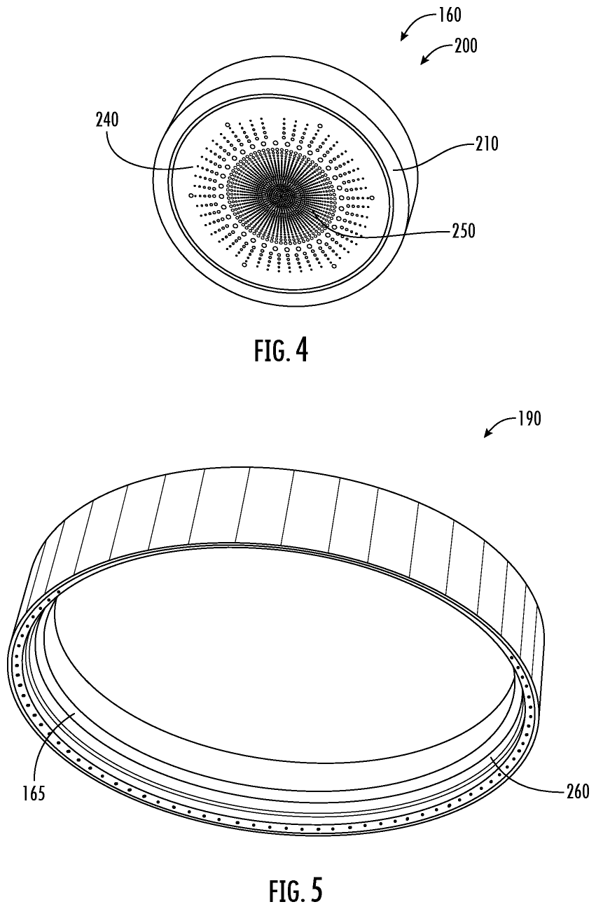

Positioned below the first shade mount 150 may be an internal spray system 160. The internal spray system 160 may be fluidly coupled to the showerhead 100 via a first water supply 120 such that the first water supply 120 may deliver a flow of water to the internal spray system 160. The internal spray system 160 may include one or more nozzles (shown as first nozzles 240 in FIG. 4) that may be configured to output water from the first water supply 120 in a variety of patterns. The internal spray system 160 may also include a light 165 (e.g., one or more lighting elements such as LEDs, bulbs, etc.), a speaker 250, and a control unit 200 operably coupled to the light and the speaker 250. The internal spray system 160 may further include one or more LED diffusers 210 which may be configured to diffuse light emitted from the internal spray system 160 to uniformly distribute the light evenly within the shower environment. The control unit 200 may be configured to control and/or manage the internal spray system 160. Additionally, the internal spray system 160 may be configured to emit sound into the shower environment.

The showerhead 100 may include a second water supply 170 (according to other exemplary embodiments, more than two water supplies may also be used). The second water supply 170 may be fluidly coupled to the first water supply 120 such that a flow of water within the first water supply 120 may be delivered into the second water supply 170. In other embodiments, the water supplies 120, 170 are individually coupled to the water source. The water supplies 120, 170 may be hollow conduits configured to deliver a flow of water from the water source to a plurality of nozzles.

The showerhead 100 may include a second spray mechanism or device that is remote or separate (e.g., located a distance away from the first spray mechanism) from the internal spray system 160, shown in FIG. 2, for example, as a rim spray 190. As illustrated, the rim spray 190 is provided in the form of a generally circular ring, although it should be understood that other configurations are possible (e.g., complete or partial rings, shapes other than circular, etc.).

The rim spray 190 may be fluidly coupled to the second water supply 170 such that the second water supply 170 may deliver a flow of water to the rim spray 190. In some embodiments, the rim spray 190 may be fluidly coupled to the first water supply 120. As shown, the rim spray 190 may be a ring concentrically provided about a lateral midpoint of the showerhead 100, where a hollow portion (e.g., hole, cavity, etc.) is provided within the center of the rim spray 190. As can be appreciated, a light emitted from the internal spray system 160 may be emitted through the hollow portion to provide light into a water spray region within the shower environment. In some embodiments, the rim spray may be integrated with the second shade mount 180. As will be discussed in greater detail herein, the rim spray 190 may include one or more nozzles provided about a circumference of the rim spray 190 and may be configured to output water from the second water supply 170.

As shown in FIG. 5, the rim spray 190 may include a second plurality of nozzles, shown as second nozzles 260. The second nozzles 260 may be configured to output a flow of water. That is, the second nozzles 260 may be fluidly coupled to the second water supply 170 such to output water from the second water supply 170. The second nozzles 260 may include a single spray mode, where the second nozzles 260 selectively receive a flow of water to output water into the single spray mode. In other embodiments, the second nozzles 260 may include one or more spray modes and/or patterns, where the second nozzles 260 actuate based on the desired spray mode. In such an embodiment, the rim spray 190 may include an internal diverter system configured to divert water to the respective second nozzles 260 based on a desired spray mode (e.g., from a first set of the second nozzles 260 to a second set of the second nozzles 260). According to an exemplary embodiment, the second nozzles 260 may output the flow of water in a direction that would apply the water distal the users head. For example, the second nozzles 260 may be directed to provide water more towards the shoulders and/or other parts of the body distal the head. As can be appreciated, this effect may create a more comfortable and relaxing shower environment.

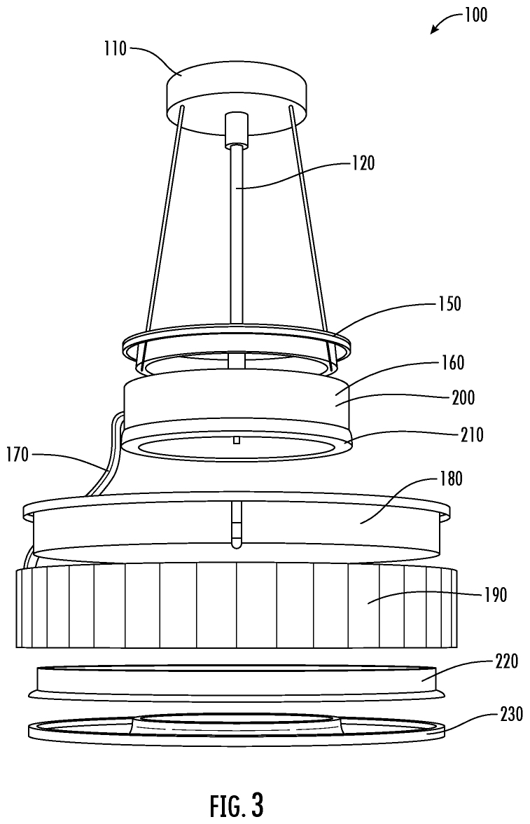

Referring now to FIGS. 3-5, the showerhead 100 may further include a control unit 200. The control unit 200 may be positioned within the internal spray system 160. In other embodiments, the control unit 200 may be a separate component from the showerhead 100, where the control unit 200 is operably coupled to the showerhead 100. Additionally or alternatively, the control unit 200 may be operably coupled to the internal spray system 160 to provide a command to at least actuate the internal spray system 160 between an on and an off mode. As shown in FIG. 4, the internal spray system 160 may further include a first LED diffuser 210, a plurality of nozzles, shown as first nozzles 240, and a speaker 250. The first LED diffuser 210 may be configured to diffuse light emitted from the internal spray system 160 to distribute the light within the shower environment. In an exemplary embodiment, the first LED diffuser 210 may be formed of a continuous piece in a ring shape around the first nozzles 240. The first LED diffuser 210 may be made of a translucent material so that the first LED diffuser 210 may diffuse light uniformly around the internal spray system 160 so as to provide an appearance reminiscent of a lighting fixture. Additionally or alternatively, the first LED diffuser 210 may be configured to protect a user from the light emitted from the internal spray system 160. For example, LED light 165 can emit a bright light that could potentially be uncomfortable for a user if the user looks directly at the light, so the first LED diffuser 210 can provide a level of protection to the user. The first LED diffuser 210 may be made of a translucent material to prevent a user from looking directly at the LED light 165. The internal spray system 160 may include multiple LED lights 165 positioned proximate a bottom and a top of the internal spray system 160. It should be understood that while a single diffuser 210 is illustrated, a plurality of diffusers having other configurations than that shown are also possible and included within the scope of the present disclosure. For example, in another embodiment the first LED diffuser 210 may be formed of a plurality of pieces that are positioned around the first nozzles 240. Additionally or alternatively, in another embodiment the first LED diffuser 210 may be formed of a plurality of pieces that cover each LED light 165 individually.

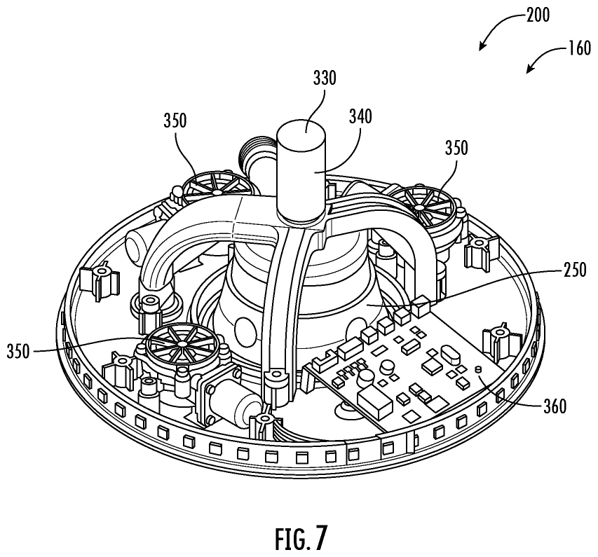

The first nozzles 240 may be configured to output a flow of water. That is, the first nozzles 240 may be fluidly coupled to the first water supply 120 so as to output water from the first water supply 120. The first nozzles 240 may include one or more spray modes and/or patterns, where the first nozzles 240 actuate based on the desired spray mode. As can be appreciated, the internal spray system 160 may include an internal diverter system (e.g., solenoid 350 in FIG. 7) configured to divert water to the respective first nozzles 240 based on a desired spray mode. In other embodiments, the diverter may be positioned distal the internal spray system 160 (e.g., in the ceiling, in the mounting bracket 110, etc.).

The speaker 250 may be operably coupled to a device. The device may be a control system, wireless device (e.g., cellular phone, music player, etc.), sound system, or the like. The speaker 250 may be configured to output sound from the speaker 250, where the sound is delivered from the device. The sound may be music, relaxation noise (e.g., background noise, etc.), any sound produced from the device, etc. The speaker 250 and/or device may be operably coupled to the control unit 200, where the control unit 200 receives a feedback from the speaker 250. The control unit 200 may be operably coupled to the internal spray system 160 to control components of the internal spray system 160. The components of the internal spray system 160 may be controlled simultaneously by the control unit 200. That is, the first LED diffuser 210, the first nozzles 240, and the speaker 250 may be controlled simultaneously so that light, spray, and sound may be emitted simultaneously to enhance the user experience. For example, the control unit 200 may actuate a diverter positioned within the internal spray system 160 to change a spray mode of the first nozzles 240. In another example, the control unit 200 may receive the feedback from the speaker 250 (e.g., frequency, pitch, etc.) and control the spray mode based upon the speaker feedback. In another example, the control unit 200 may control a level and color of light emitted from the internal spray system 160 based upon the speaker feedback. In another example the control unit 200 may simultaneously control the spray mode, the brightness and color of light, and the sound emitted based on desired conditions.

WM Referring still to FIGS. 3-5, the showerhead 100 may include a second LED diffuser 220 (or, in some embodiments, a plurality of LED diffusers). The second LED diffuser 220 may be substantially similar to the first LED diffuser 210. The second LED diffuser 220 may be configured to diffuse light emitted from the internal spray system 160 to uniformly distribute the light evenly within the shower environment. In an exemplary embodiment, the second LED diffuser 220 may be formed of a continuous piece in a ring shape. The second LED diffuser 220 may be made of a translucent material so that the second LED diffuser 220 may diffuse light around the internal spray system 160 so as to provide an appearance reminiscent of a lighting fixture. Additionally or alternatively, the second LED diffuser 220 may be made of a translucent material to prevent a user from looking directly at the LED light 165. The second LED diffuser 220 may be provided internal to the rim spray 190 such to prevent the second LED diffuser 220 from blocking the second nozzles 260. It should be understood that while a single diffuser 220 is illustrated, a plurality of diffusers having other configurations than that shown are also possible and included within the scope of the present disclosure. For example, in another embodiment the second LED diffuser 220 may be formed of a plurality of pieces positioned proximate the rim spray 190. Additionally or alternatively, in another embodiment the second LED diffuser 220 may be formed of a plurality of pieces that cover each LED light 165 individually.

The showerhead 100 may further include a ceiling mount diffuser 230. The ceiling mount diffuser 230 may be substantially similar to the LED diffusers 210, 220. The ceiling mount diffuser 230 may define an annular profile with a hollow portion centrally provided therein. The ceiling mount diffuser 230 may be configured to diffuse light from the internal spray system 160 while permitting the flow of water from the showerhead 100 to the shower environment. As can be appreciated, the ceiling mount diffuser 230 may be provided outward the first nozzles 240 and inward the second nozzles 260 to permit the flow of water from the nozzles 240, 260.

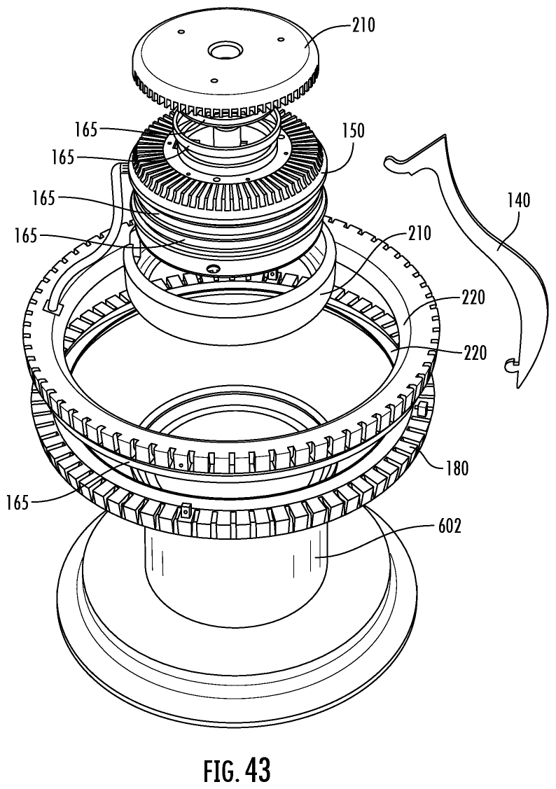

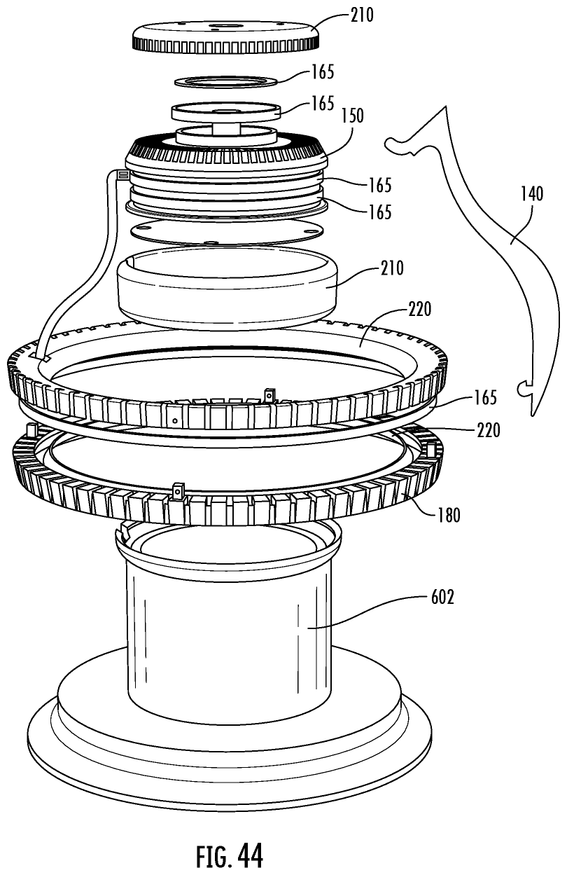

FIGS. 43-44 show a jig 602 used to assemble the fins 140 to a first shade mount 150 and a second shade mount 180. The first shade mount 150 and the second shade mount 180 may be placed on the jig 602 so that the fins 140 can be easily secured to the first shade mount 150 and the second shade mount 180. Once secured, the fins 140 may surround or partially surround the first LED diffuser 210 and the second LED diffuser 220. Both the first LED diffuser 210 and the second LED diffuser 220 may be made from a translucent material to shield the user from directly looking at the LED light 165. Additionally or alternatively, both the first LED diffuser 210 and the second LED diffuser 220 may be made from a translucent material to distribute light uniformly around the showerhead 100 so as to provide an appearance reminiscent of a lighting fixture. In an exemplary embodiment, the first LED diffuser 210 may be configured to be two separate pieces that fit together to diffuse the LED light 165. One piece is a top portion that fits over the fins 140, and the other piece is a bottom portion that fits under the first shade mount 150. The first LED diffuser 210 surrounds the LED lights 165 to diffuse light to create an enjoyable atmosphere. In an exemplary embodiment, the second LED diffuser 220 may be configured to be two separate pieces that fit together to diffuse the LED light 165. The second LED diffuser 220 is positioned on the inner surface of the second shade mount 180 and diffuses LED light 165 at least in a direction toward the central axis of the showerhead 100. Additionally or alternatively, each of the first LED diffuser 210 and the second LED diffuser 220 may be made from a plurality of pieces that form a ring shape wherein the pieces are not formed continuously. Additionally or alternatively, each of the first LED diffuser 210 and the second LED diffuser 220 may be made from a plurality of pieces that individually cover each LED light 165. The jig 602 may be used during initial manufacturing to couple the fins 140 to the first shade mount 150 and the second shade mount 180. The jig 602 may also be used by a consumer to replace the fins 140 with fins 140 of a similar or different shape or style.

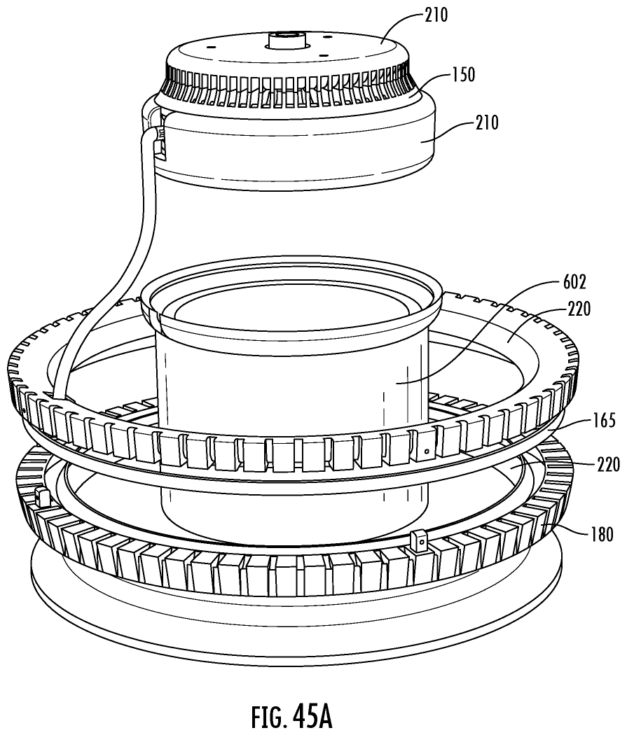

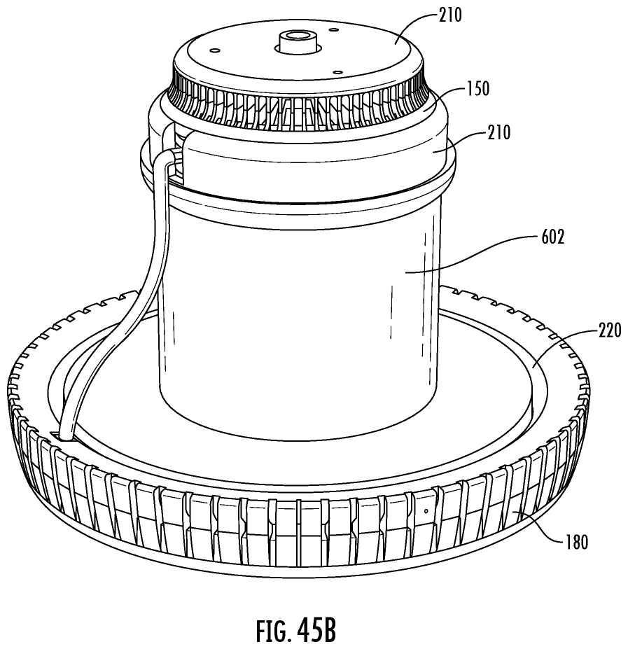

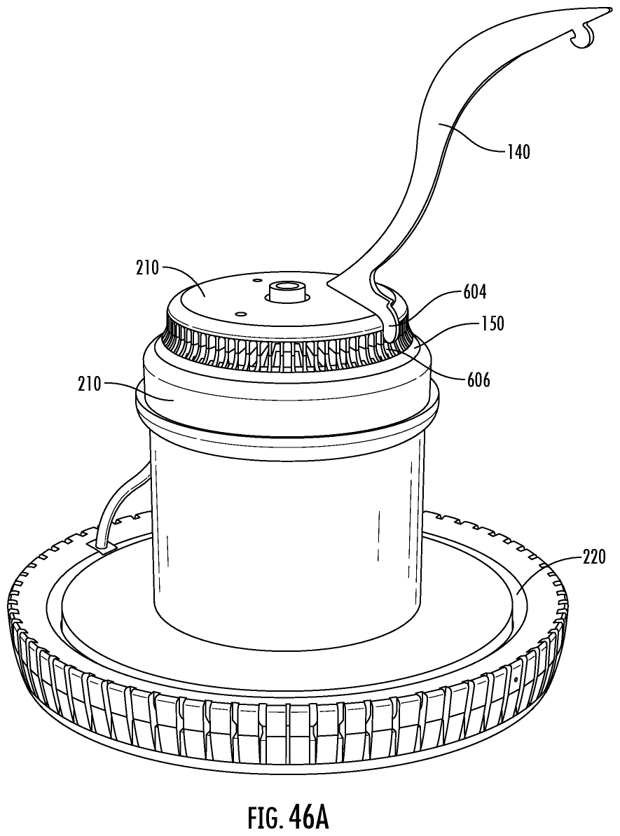

The method for assembling the fins 140 is shown in FIGS. 45A-50B. FIGS. 45A-45B show step 1 of the method. FIG. 45A includes an assembled first shade mount 150 coupled to an unassembled second shade mount 180. FIG. 45B includes placing the assembled first shade mount 150 coupled to an assembled second shade mount 180 on the jig 602.

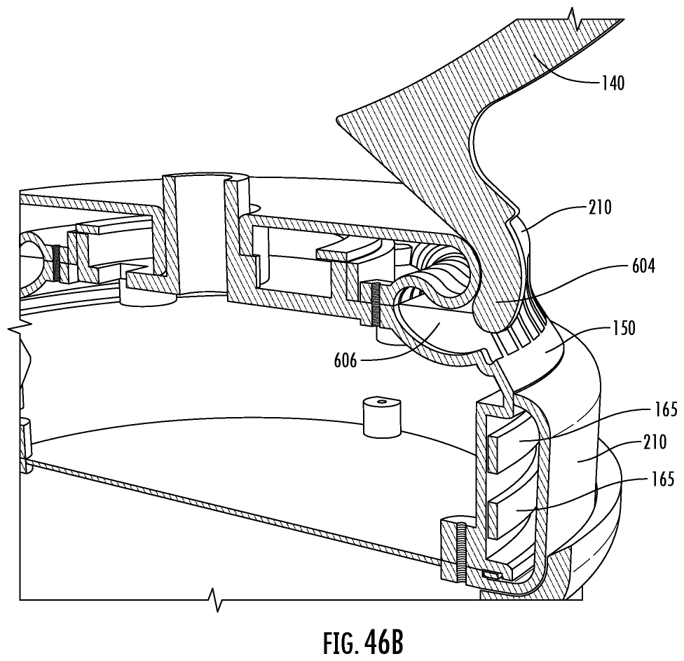

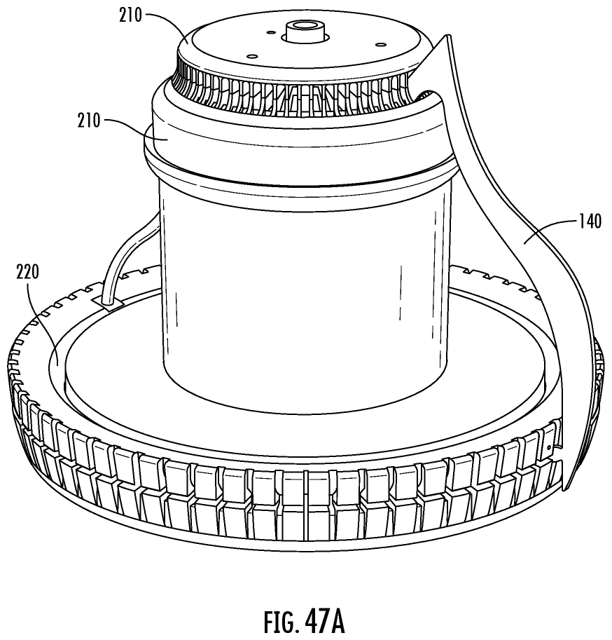

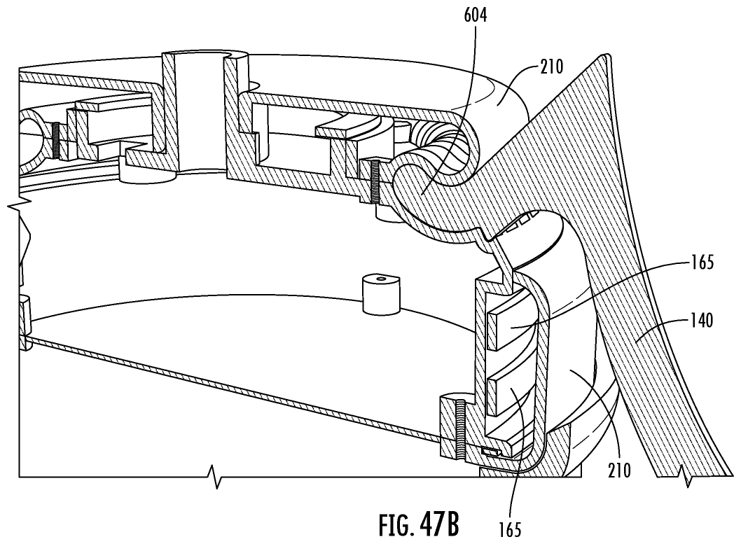

FIGS. 46A-47B show step 2 of the method. FIGS. 46A-46B include inserting a fin 140 into the first shade mount 150 by rolling a first end 604 of the fin 140 into a slot 606 in the first shade mount 150. The first end 604 of the fin 140 has a curved tip so that it can roll into the slot 606 in the first shade mount 150. FIGS. 47A-47B show the first end 604 of the fin 140 completely inserted into the slot 606 in the first shade mount 150. The curved design of the slot 606 allows for the first end 604 of the fin 140 to be securely fastened in the slot 606. To remove the first end 604 of the fin 140, the fin 140 may be rotated in the reverse direction of the direction of insertion.

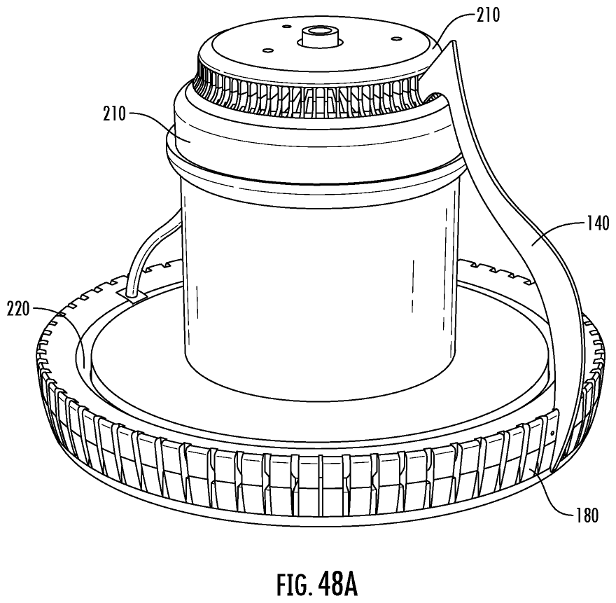

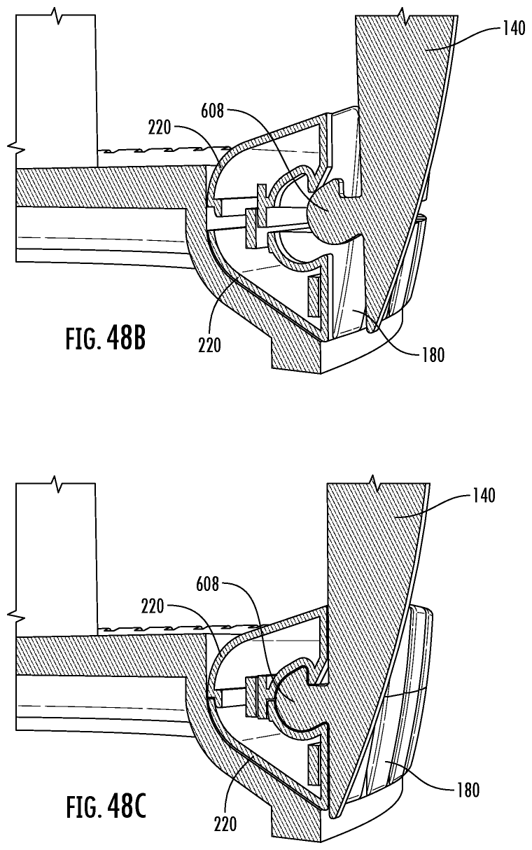

FIGS. 48A-48C show step 3 of the method. FIG. 48A shows a second end 608 of the fin 140 completely inserted into the second shade mount 180. FIG. 48B shows a second end 608 of the fin 140 being inserted into the second shade mount 180. When the second end 608 of the fin 140 is being inserted into the second shade mount 180, the fin 140 lifts the upper portion of the second shade mount 180. The second end 608 of the fin 140 lifts the upper portion of the second shade mount 180 until the second end 608 of the fin 140 is fully inserted into the second shade mount 180. Once the second end 608 of the fin 140 is completely inserted into the second shade mount 180 as shown in FIG. 48C, the second end 608 of the fin 140 is secured into the second shade mount 180. The second end 608 of the fin 140 may be removed from the second shade mount 180 by lifting the upper portion of the second shade mount 180 and removing the second end 608 of the fin 140 from the second shade mount 180.

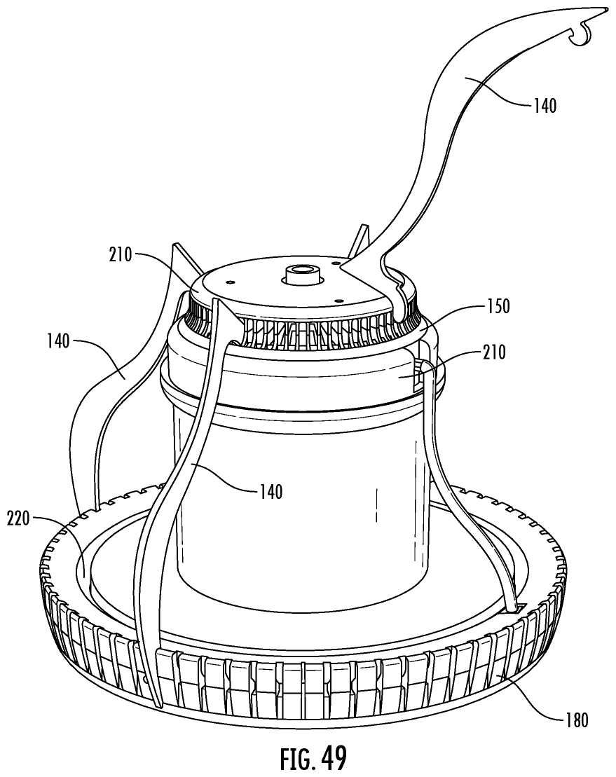

FIG. 49 shows step 4 of the method. FIG. 49 shows a plurality of fins 140 inserted into and coupled to the first shade mount 150 and the second shade mount 180. A user may customize the number of fins 140 to be inserted into the first shade mount 150 and the second shade mount 180 to form the overall shape of the showerhead.

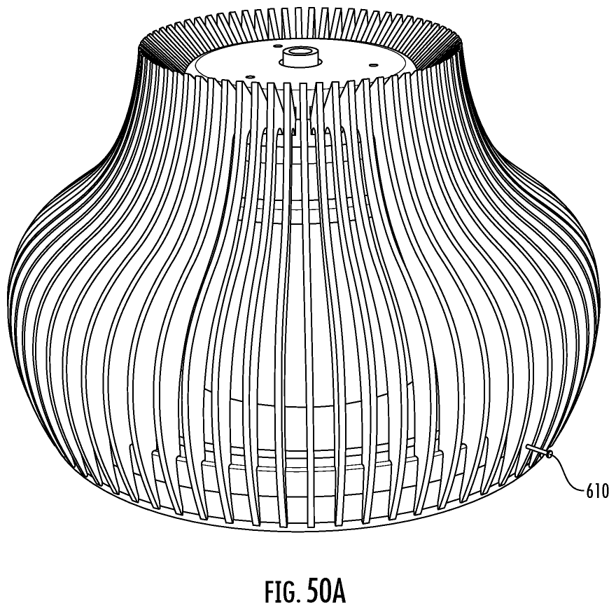

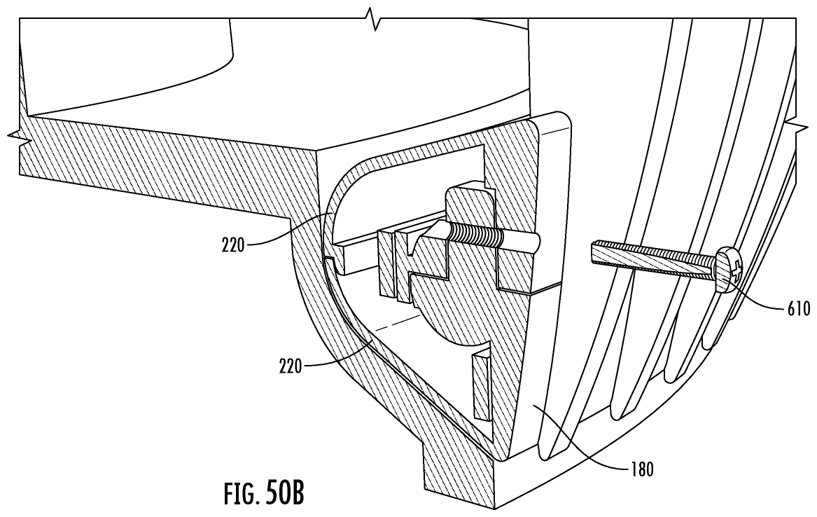

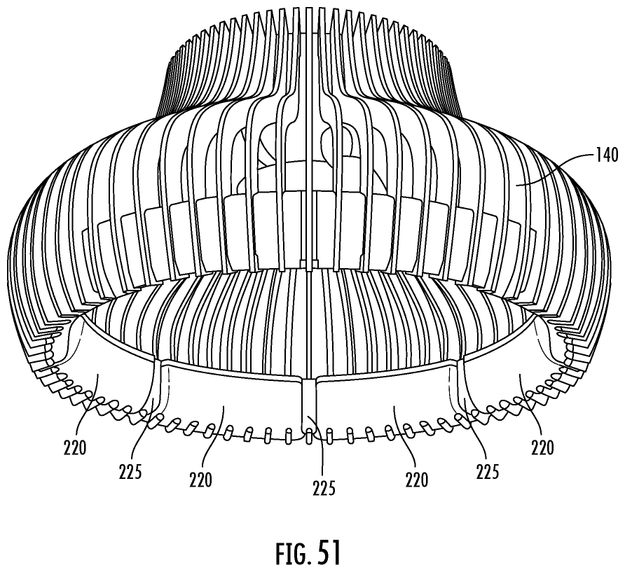

FIGS. 50A-50B show step 5 of the method. FIG. 50A shows the first shade mount 150 and the second shade mount 180 coupled to the maximum number of fins 140 and secured with a fastener 610, such as but not limited to a screw. FIG. 50B shows fastening the upper portion of the of the second shade mount 180 to the lower portion of the second shade mount 180 using the fastener 610. Once the upper portion of the second shade mount 180 and the lower portion of the second shade mount 180 are fastened together, the fins 140 are locked into place and cannot be removed without removing the fastener 610.

Referring now to FIGS. 51-60, a showerhead is shown according to another exemplary embodiment. FIG. 51 shows a perspective view of the showerhead. The showerhead may be substantially similar to showerhead 100 described above. The showerhead according to this exemplary embodiment includes fins 140 that surround the second LED diffuser assembly 220. The second LED diffuser assembly 220 may include a plurality of different segments or portions that may be made from a translucent material to shield the user from directly looking at the LED lights. Additionally or alternatively, the second LED diffuser assembly 220 may be made from a translucent material to distribute light uniformly around the showerhead so as to provide an appearance reminiscent of a lighting fixture. The second LED diffuser assembly 220 may be made from a plurality of pieces or segments that couple together using clips 225, wherein the pieces are not formed continuously. The second LED diffuser assembly 220 may diffuse LED light 165 at least in a direction toward the central axis of the showerhead.

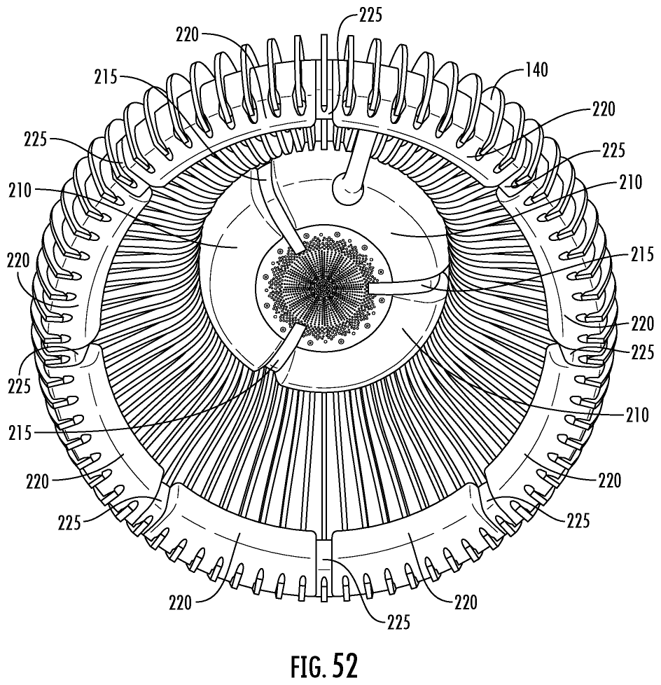

FIG. 52 shows a perspective view of the showerhead. The showerhead includes fins 140 that surround the first LED diffuser assembly 210. The first LED diffuser assembly 210 may also include a plurality of segments or portions that may be made from a translucent material. Additionally or alternatively, the first LED diffuser assembly 210 may be made from a translucent material to distribute light uniformly around the showerhead so as to provide an appearance reminiscent of a lighting fixture. The first LED diffuser assembly 210 may be made from a plurality of pieces that couple together using clips 215, wherein the pieces are not formed continuously.

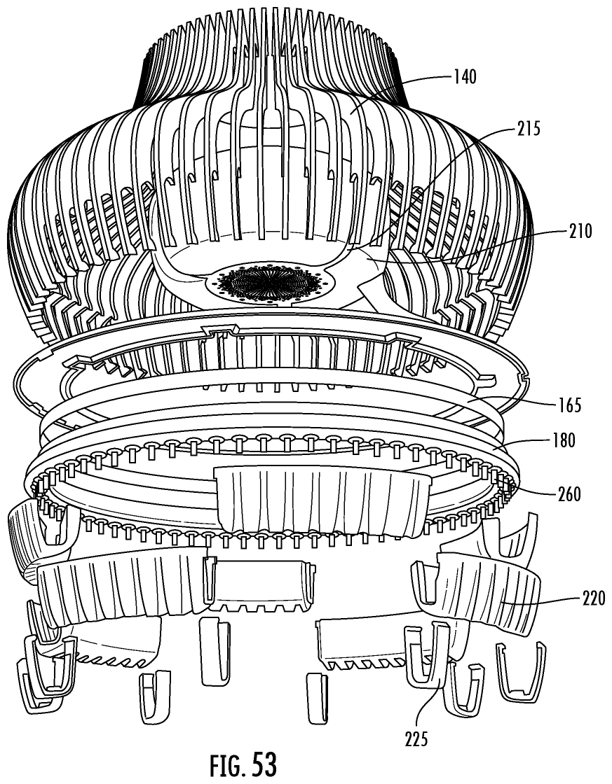

FIG. 53 shows an exploded view of the showerhead. The showerhead may include fins 140 that surround the first LED diffuser assembly 210 and the second LED diffuser assembly 220. The showerhead may include the first LED diffuser assembly 210 formed of a plurality of separate pieces that couple together using clips 215. The showerhead also may include the second shade mount 180 that may be concentrically provided about the showerhead. The second shade mount 180 may include one or more notches, protrusions, fasteners, interfaces, or the like, configured to engage the fins 140. The showerhead may include second nozzles 260 which may be configured to output a flow of water. The showerhead also may include the LED light 165 that may be concentrically provided about the showerhead. The showerhead may also include the second LED diffuser assembly 220 formed of a plurality of separate pieces that couple together using clips 225.

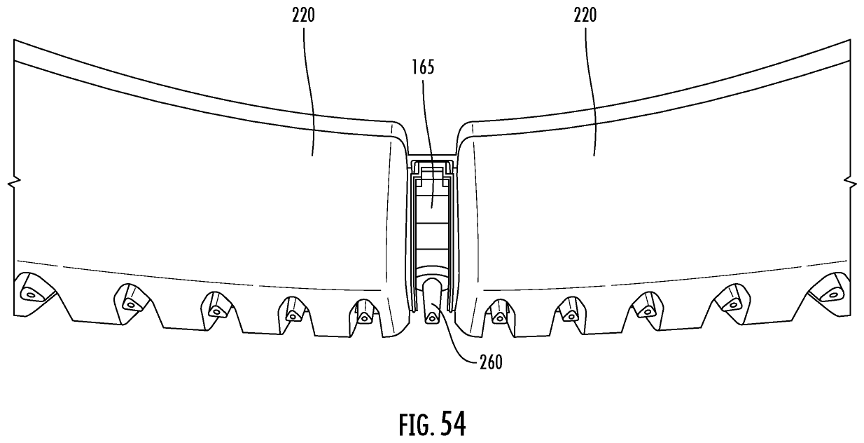

FIG. 54 shows a detailed view of a portion of the second LED diffuser assembly 220. The second LED diffuser assembly 220 may be formed of a plurality of separate pieces. The second LED diffuser assembly 220 may fit around the second nozzles 260. In this view, the clip 225 that couples the pieces of the second LED diffuser assembly 220 is not pictured and the LED light 165 is shown. The LED light 165 may emit light through the second LED diffuser assembly 220 at least in a direction toward the central axis of the showerhead.

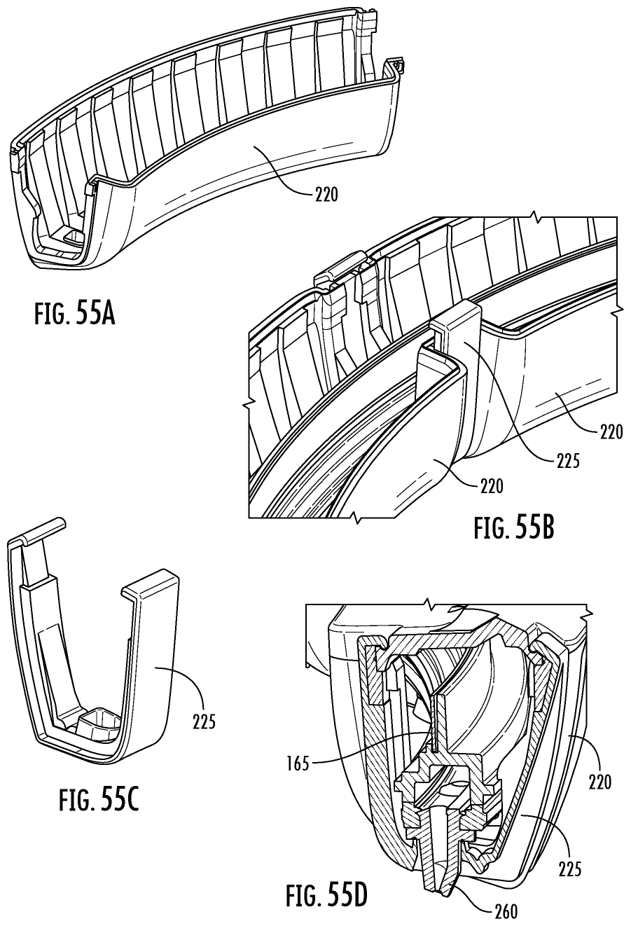

FIG. 55A shows a perspective view of the second LED diffuser assembly 220. The second LED diffuser assembly 220 may be hollow so that it can fit around the second nozzles 260 and the LED light 165. FIG. 55B shows a detailed view of the second LED diffuser assembly 220 and the clip 225. The clip 225 may couple the plurality of pieces of the second LED diffuser assembly 220 together, wherein the pieces are not formed continuously. FIG. 55C is a perspective view of the clip 225 that may couple the plurality of pieces of the second LED diffuser assembly 220. FIG. 55D is a detailed view of a cross-section of the second LED diffuser assembly 220 and the clip 225. The LED light 165 may be diffused through the second LED diffuser assembly 220. The clip 225 and the second LED diffuser assembly 220 may be formed so that the second nozzles 260 may fit through them.

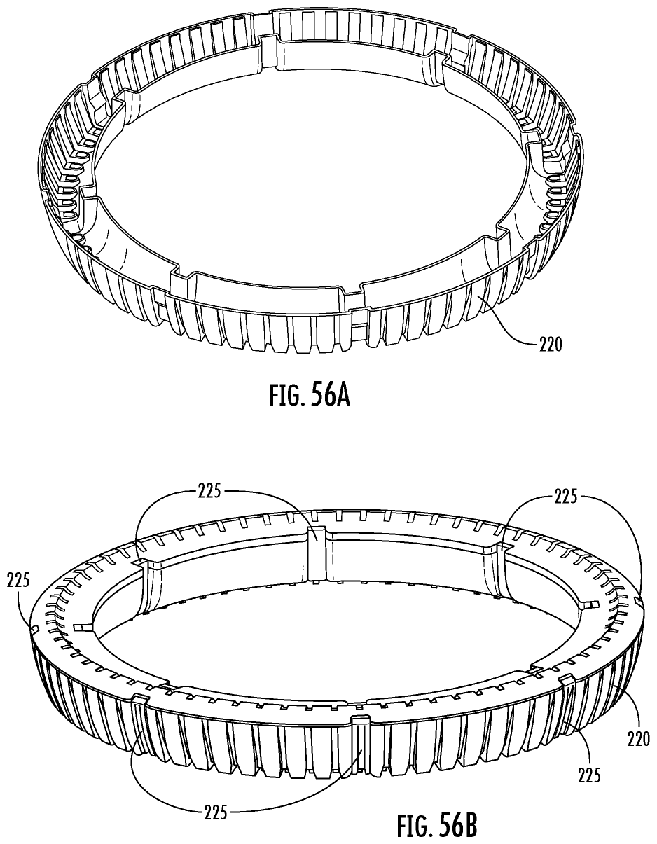

FIGS. 56A and 56B show two perspective views of another embodiment of the second LED diffuser assembly 220. The second LED diffuser assembly 220 in this embodiment may be formed of a continuous piece instead of a plurality of separate pieces. The clips 225 may attach to the second LED diffuser assembly 220 so that light from the LED light 165 may not be diffused through the clips 225. Therefore, light may not be diffused in a continuous ring around the showerhead.

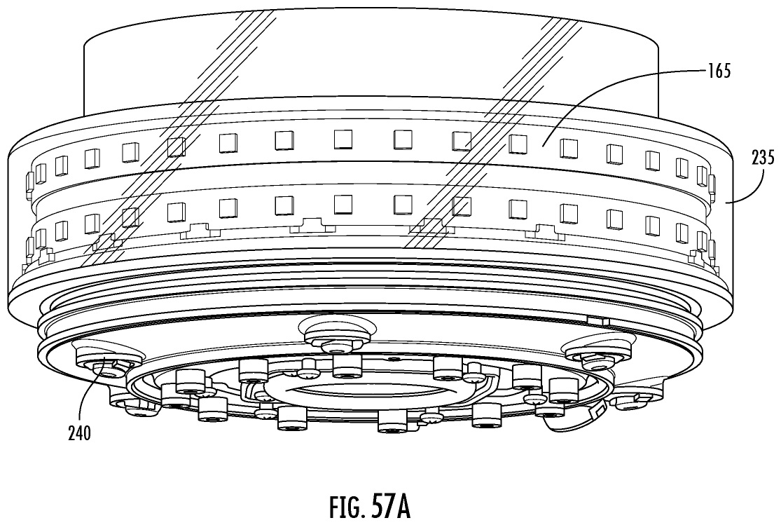

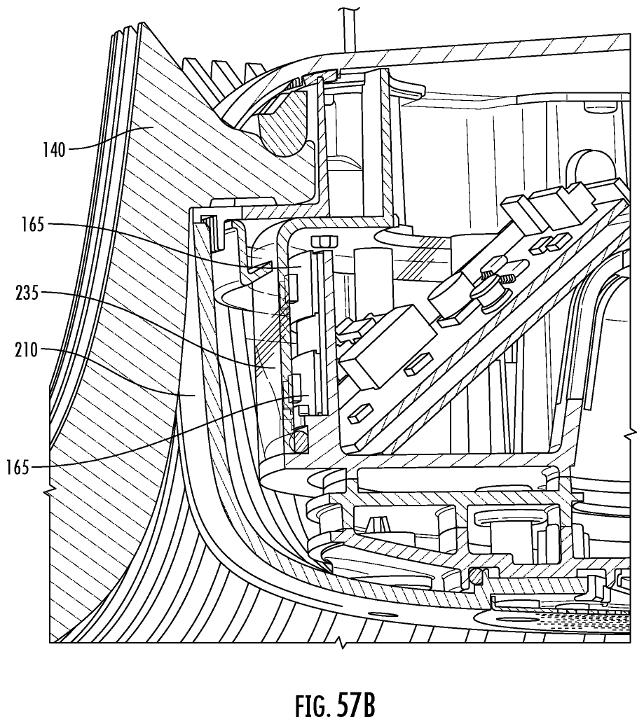

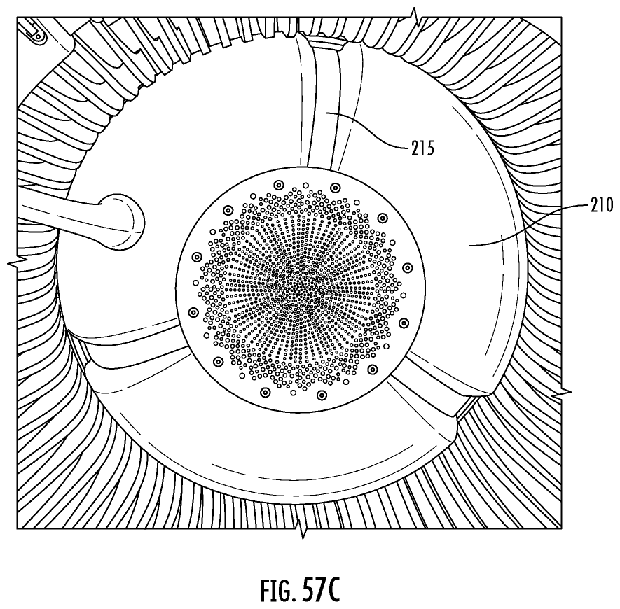

FIGS. 57A-57C show views of another embodiment of the showerhead. As shown in FIG. 57A, the LED light 165 may be surrounded by a first transparent covering 235. The first transparent covering 235 may be configured to protect the LED light 165 from water in the showerhead or water that may be emitted from the first nozzles 240. The first transparent covering 235 may not diffuse light due to its transparent quality. Rather, light emitted from the LED light 165 may pass through the first transparent covering 235, and further, may be diffused through the first LED diffuser assembly 210. FIG. 57B shows a detailed view of the LED light 165, the first transparent covering 235, the first LED light diffuser assembly 210, and the fins 140. FIG. 57C shows a perspective view of the showerhead. The first transparent covering 235 may not be visible through the first LED diffuser assembly 210. Additionally, the first LED diffuser assembly 210 may be made of a plurality of pieces that are coupled together by clips 215.

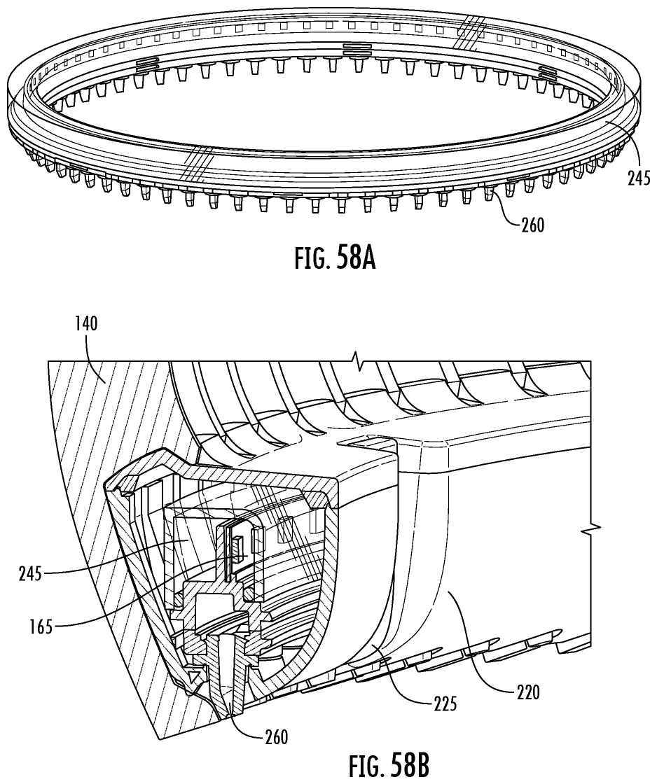

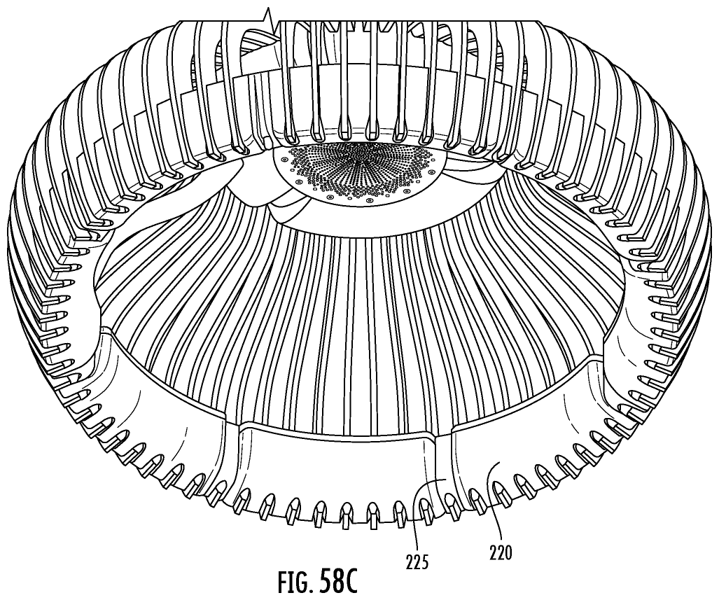

FIGS. 58A-58C show views of another embodiment of the showerhead. As shown in FIG. 58A, the LED light 165 may be surrounded by a second transparent covering 245. The second transparent covering 245 may be configured to protect the LED light 165 from water in the showerhead or water that may be emitted from the second nozzles 260. The second transparent covering 245 may not diffuse light due to its transparent quality. Rather, light emitted from the LED light 165 may pass through the second transparent covering 245, and further, may be diffused through the second LED diffuser assembly 220. FIG. 58B shows a detailed view of the LED light 165, the second transparent covering 245, the second LED light diffuser assembly 220, the clip 225, the second nozzles 260, and the fins 140. FIG. 58C shows a perspective view of the showerhead. The second transparent covering 245 may not be visible through the second LED diffuser assembly 220. Additionally, the second LED diffuser assembly 220 may be made of a plurality of pieces that are coupled together by clips 225.

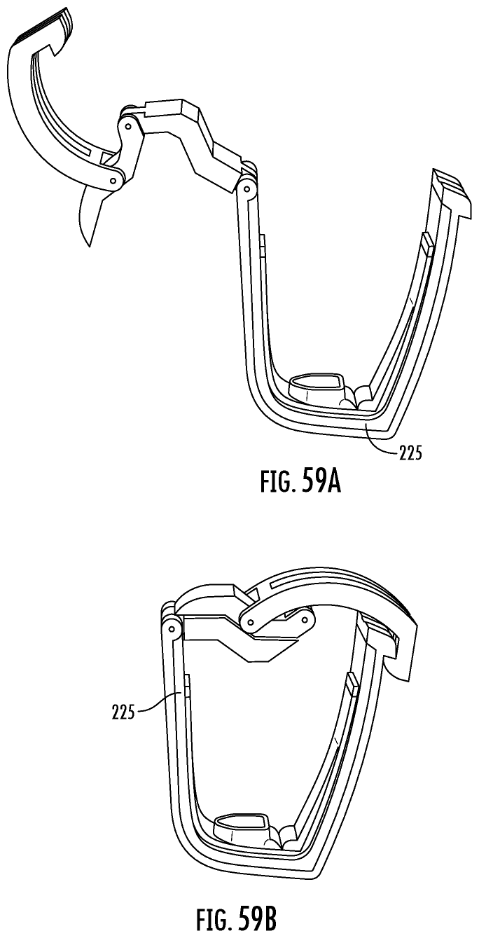

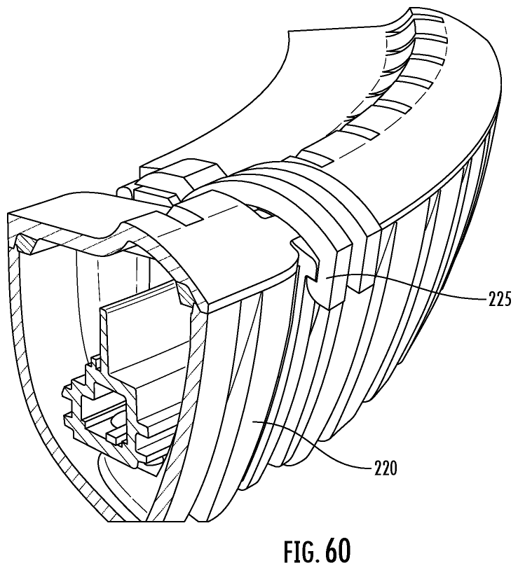

FIGS. 59A and 59B show views of clip 225. The clip 225 may be connected to the second LED diffuser assembly 220 to couple the plurality of pieces together. The clip 225 may open for easier attachment to the second LED diffuser 220. FIG. 60 shows a perspective view of the clip 225 connected to the second LED diffuser 220 and coupling the pieces of the second LED diffuser assembly 220 together. According to an exemplary embodiment, the clip 225 includes multiple segments joined together by hinges to allow for the opening and closing movement of the clip. The clip also includes complementary features for coupling the distal end of the clip to the main body of the clip so as to secure it in place when coupling adjacent segments of the LED diffuser assembly 220 together.

Referring now to FIG. 7, a detailed view of the internal spray system 160 is shown according to one exemplary embodiment. The control unit 200 may receive a flow of water from the first water supply 120. The flow of water may be delivered to a flow regulator 330. By way of example, the flow regulator 330 may be configured to output at least one of a 2.5 GPM and a 1.75 GPM flow. The flow regulator 330 may be configured to regulate the flow of water delivered to the internal spray system 160. More specifically, the flow regulator 330 may be configured to regulate the flow of water delivered to an air pump 340. The air pump 340 may be fluidly coupled to the flow regulator 330. In other embodiments, the air pump 340 may be directly coupled to the first water supply 120. The air pump 340 may be configured to permit activation to one or more solenoid valves, shown as solenoid valves 350. The solenoid valves 350 may be selectively repositionable between an open position and a closed position. As can be appreciated, the solenoid valves 350 permits a flow of water to the first nozzles 240 when the solenoid valve 350 is in the open position. According to an exemplary embodiment, the internal spray system 160 may include three solenoids 350, where each solenoid valve 350 opens and closes in approximately 0.5 seconds. Each solenoid 350 may be configured to direct a flow of water to a desired spray pattern and/or outlet. For example, a first solenoid 350 may be fluidly coupled to a first spray pattern; a second solenoid 350 may be fluidly coupled to a second spray pattern; and a third solenoid 350 may be fluidly coupled to the second water supply 170. The internal spray system 160 further includes a control board 360. As will be discussed in FIG. 8, the control board 360 may be configured to receive a command to control the internal spray system 160.

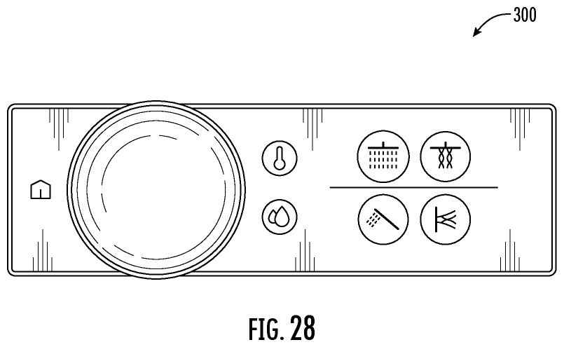

Referring now to FIG. 8, a control system for the internal spray system 160 is shown. The control system may be configured to send a command to the internal spray system 160 to actuate one or more components of the internal spray system 160 (e.g., speaker 250, etc.). The control system may include the control unit 200. The control unit 200 may be operably coupled to the control board 360. The control unit 200 may be configured to receive a command from at least one of a controller (e.g., controller 300 of FIG. 28) and a digital device 310. Additionally or alternatively, the control unit 200 may be configured to store programs of the showerhead 100 (e.g., shower program, music, valve controls, etc.). That is, the control unit 200 may be configured to receive at least one of a spray select, shower program, music play select, speaker volume, light actuation, light color, and Bluetooth pairing signal from the controller 300. Additionally or alternatively, the digital device 310 may be communicably coupled to the control unit 200 (e.g., via Bluetooth, Wi-Fi, etc.). The digital device 310 may be configured to provide at least one of a shower program download, shower program customization, light actuation, light theme, light brightness, theme sound, music menu (e.g., playlist), music streaming application, and additional digital applications. The control board 360 may be configured to receive these commands and actuate the internal spray system 160 and/or control unit 200 accordingly.

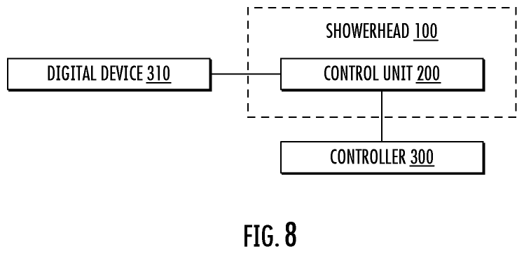

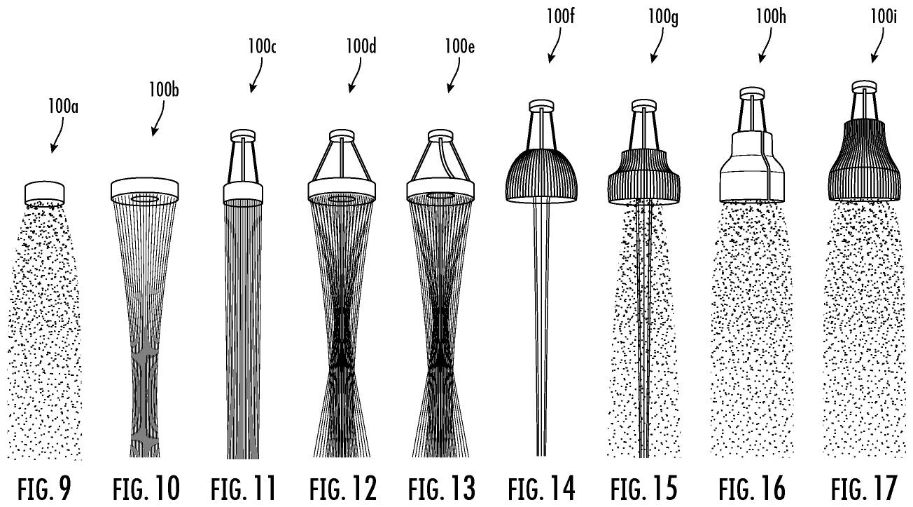

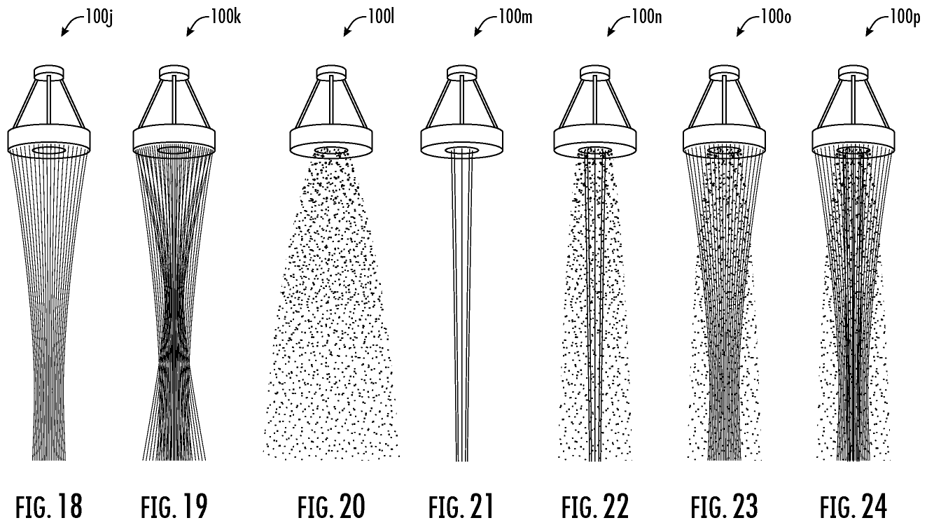

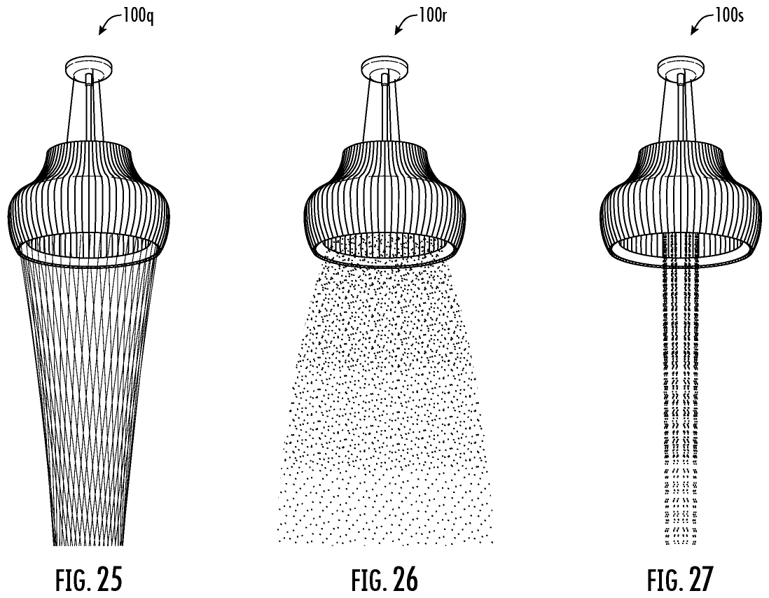

Referring now to FIGS. 9-27, various configurations of showerheads 100 are shown. A showerhead (e.g., showerhead 100a, 100b, 100c, 100d, 100e, 100f, 100g, 100h, 100i, 100j, 100k, 100l, 100m, 100n, 100o, 100p) may have a different combination of features of the showerhead 100. As shown in FIGS. 9-17, a showerhead (e.g., showerhead 100a, 100b, 100c, 100d, 100e, 100f, 100g, 100h, 100i) may have a different combination of features (e.g., sound, light, spray pattern, shower theme, etc.). For example, the showerheads 100a-100d and 100f-100i may include a touchless controller, multiple spray patterns, multiple light colors, and sound capabilities. In yet another example, the showerhead 100e may include a single light color, two spray patterns, and no music. As shown in FIGS. 18-27, a showerhead (e.g., showerhead 100j, 100k, 100l, 100m, 100n, 100o, 100p, 100q, 100r, 100s) may have at least one of a spray mode. The spray modes may vary based on the number of water drops and diameter of drops. The spray mode may be a welcome rain, shown in FIG. 18; a rain shower, shown in FIG. 19; a cool rain, shown in FIG. 20; a rainfall, shown in FIG. 21; a summer rain, shown in FIG. 22; a spring rain, shown in FIG. 23; a rainy season, shown in FIG. 24; a sunshower, shown in FIG. 25, a drizzle, shown in FIG. 26, and a spout, shown in FIG. 27. In other embodiments, the spray mode may provide the experience of a mist/fog, a light rain, a moderate rain, a tropical rain, a heavy rain, a thunderstorm, a concentrated rain, or a cloudburst, etc. In other embodiments, the showerhead 100 may include spray modes that may include variations in water spray intensity, music, and light. In other embodiments, the showerhead 100 may include more spray modes. As shown in FIGS. 9-27, the showerhead 100a-100s may take on any geometrical configuration having any combination of features therein.

Referring now to FIG. 28, the showerhead 100 may be operably coupled to a controller 300. The controller 300 is operably coupled to the showerhead 100. The controller 300 may be configured to send signals to the showerhead 100 to control the features (e.g., sound, light, spray pattern, shower theme, etc.). The features may be presets on the controller 300, where each feature can be controlled independently. The signals sent by the controller 300 may be configured to at least provide commands to turn on the sound, change a volume of the sound, change the spray pattern, change a brightness and/or color of the light, etc. The features (e.g. sound, light, spray pattern, shower theme, etc.) may be selected so that the user may experience multiple features simultaneously. The features may be customizable so that the user may customize a shower experience. The controller 300 may be configured to be a wireless device. For example, the controller 300 may not need a communication cable to link to the showerhead 100. The controller 300 may be defined to be selectively repositionable about the shower environment (e.g., mobile). The controller 300 may be selectively coupled to the shower environment by a coupling device (e.g., magnet, screw, bolt, suction, etc.). In some embodiments, the controller 300 may not be selectively repositionable about the shower environment and instead may be fixedly coupled to the shower environment.

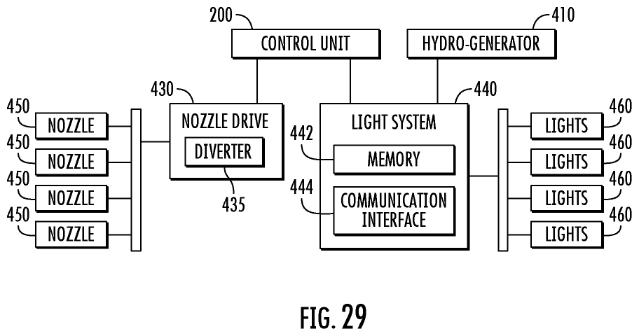

Referring to FIG. 29, the showerhead 100 may include a nozzle driver 430 coupled to a plurality of nozzles 450, and a light system 440 communicably coupled to a plurality of lights 460. Both the nozzle driver 430 and the light system 440 may be operably coupled to the control unit 200. The nozzles 450 may be located within the showerhead 100. The nozzle driver 430 may include a diverter 435 (e.g., solenoid valve 350) configured to direct a flow of water to desired nozzles 450 to actuate a spray mode. The lights 460 may be located within the showerhead 100, proximate nozzles 450. The light system 440 may include a memory 442 and a communications interface 444. As described in greater detail below, the showerhead 100 may be configured to determine various conditions of water output from the nozzles 450, and control the lights 460 to output light having a state corresponding to the determined conditions. That is, the showerhead 100 may be configured to generate control signals to turn on and off various lights 460, dim various lights 460, change a color or warmth of light output from the lights 460, change spray modes and so forth based on a program.

The lights 460 may be light emitting diodes (LEDs), organic LEDs, plasma display panel (PDP), liquid crystal display LCD), or other types or forms of lights. The lights 460 may be configured to output light by receiving a control signal from the light system 440. The lights 460 may be configured to have various states. The states may be, for instance, an on state (e.g., where the lights 460 output light), an off state (e.g., where the lights 460 do not output light), a dim state (e.g., where the lights 460 output light having a luminescence or brightness less than the on state), various colored states, and so forth. The lights 460 may be configured to output light having a selectable color within the visible color spectrum. In some embodiments, the showerhead 100 may include several zones of lights. Each zone may be dedicated to a particular color. The showerhead 100 may include any number of zones. In some embodiments, the lights 460 may be configured to output light in the warm light spectrum (e.g., between 2000 kelvin (K) and 3000 K), in the cool light spectrum (e.g., between 3100 K and 4500 K), in the daylight spectrum (e.g., between 4600 K and 6500 K), and/or various other color temperatures (e.g., between 1000 K and 2000 K, between 6500 K and 10,000 K, etc.). The lights 460 may be configured to convey various information as well as providing ambient lighting conditions within the shower space, as described in greater detail below.

The showerhead 100 may include a power source. In some embodiments, the power source may be internal to the showerhead 100. For instance, the power source may be a hydro-generator 410 (e.g., a micro hydro-generator). The hydro-generator 410 may be installed in-line between the water source and the nozzles 450 of the showerhead 100. The hydro-generator 410 may be configured to generate power as water flowing from the water source turns a turbine within the hydro-generator 410. The hydro-generator 410 may be configured to generate power to charge an internal battery (and/or capacitor) of the showerhead 100, which in turn powers various electrical components of the showerhead 100 (e.g., the light system 440, the lights 460, etc.). In embodiments in which the hydro-generator 410 generates power to charge (at least) a capacitor, the capacitor may act as a “temporary battery” by discharging during instances of intermittent power generation via the hydro-generator 410 to stabilize brightness or consistency of the lights 460. While described as a hydro-generator 410, it is noted that the showerhead 100 may include various other types or forms of power sources internal to the showerhead 100 (e.g., one or more batteries such as lithium-ion batteries, etc.) which may be removable from the showerhead 100 for charging and/or replacing. Additionally, the showerhead 100 may be powered by various external power sources.

The showerhead 100 may include the control unit 200. The control unit 200 may be configured to provide a programmed command to at least the nozzle driver 430 and the light system 440. In other embodiments, the control unit 200 may be communicably coupled to one of the nozzle driver 430 and the light system 440. The control unit 200 may be configured to provide the programmed command to the nozzle driver 430 and the light system 440, where the programmed command has at least one pre-set condition. The programmed command may provide a spray pattern sequence, light sequence, etc. More specifically, the programmed command may provide a combination of spray patterns and light condition based on timing. For example, the programmed command may provide a command to the nozzle driver 430 to have a first spray pattern for three seconds, transition to a third spray pattern for ten seconds, transition to a combination of a second spray pattern and a fourth spray pattern for six seconds, etc. Simultaneously, the programmed command may send a similar command to the light system 440. For example, the control unit 200 may provide a command substantially similar to the nozzle driver command, where the light system 430 may have a first lighting condition for three seconds, transition to a third lighting condition for ten seconds, etc.

The control unit 200 may be configured to determine various conditions corresponding to the showerhead 100 based upon the programmed command. The conditions may be or include light color, light brightness, spray mode, sound, aroma, etc. The control unit 200 may be configured to use the condition(s) corresponding to the showerhead 100 for generating control signals to control spray mode and light output from the lights 460. According to the embodiments described herein, the control unit 200 may control the spray mode through the nozzles 450 and the lights 460 to provide the user with both modulating spray mode of the showerhead 100 and ambient lighting conditions within the shower space.

The condition may be a spray mode. The control unit 200 may be communicably coupled to the nozzle driver 430. The control unit 200 may be configured to generate a command for the nozzle driver 430, where the nozzle driver 430 may change a spray mode from the nozzles 450 based on the command. That is, the nozzle driver 430 may change the spray mode in sequence or pattern of the command. For example, if the control unit 200 provides a first programmed command, the nozzle driver 430 may actuate into a first programmed spray mode. In such an example, the nozzle driver 430 may slowly transition between soft spray modes based on the pre-set program conditions. In yet another example, if the control unit 200 provides a second programmed condition, the nozzle driver 430 may actuate into a second programmed spray mode. In such an example, the transition between the spray modes may be fluent to eliminate body shock on the user.

The condition may be a light condition. The control unit 200 may be communicably coupled to the light system 440. The control unit 200 may be configured to generate a command for the light system 440, where the light system 440 may change a condition of the lights 460 based on the command. That is, the light system 440 may change a brightness and/or color of the lights 460 in sequence or pattern of the command. For example, if the control unit 200 provides a first programmed command, the light system 440 may actuate the lights 460 into a first programmed light mode. In such an example, the light system 440 may control the lights 460 to produce a color light having softer colors, where the colors are slowly transitioned therebetween. In yet another example, if the control unit 200 provides a second programmed command, the light system 440 may actuate the lights 460 into a second programmed light mode. In such an example, the transition between the light colors may be fluent to eliminate body shock on the user.

In some embodiments, the condition may be an aroma. In such an embodiment, the showerhead 100 may be configured to emit an aroma into the shower environment based on the signal generated from the control unit 200. The aroma could be a single aroma or could be a combination of multiple types of aromas. In some embodiments, the condition may be a sound. In such an embodiment, the showerhead 100 may be configured to emit a sound into the shower environment based on the signal generated from the control unit 200.

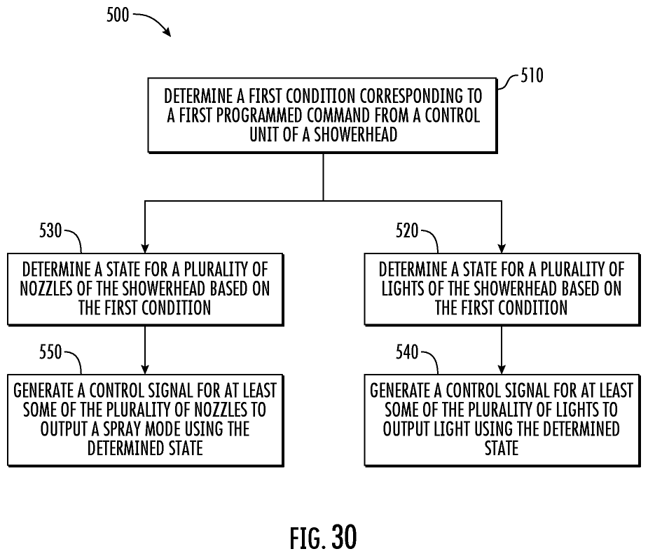

Referring now to FIG. 30, depicted is a flowchart showing a method 500 of controlling a showerhead 100 in a shower space, according to an illustrative embodiment. The method 500 may be implemented by the components described above with reference to FIG. 1 through FIG. 24. As a brief overview, at step 510, a pre-programmed command determines a first condition corresponding to a showerhead 100. At step 520, the light system 440 determines a state for a plurality of lights 460 of the showerhead 100 based on the first condition. At step 530, the nozzle driver 430 determines a state for a plurality of nozzles 450 of the showerhead 100 based on the first condition. At step 540, the light system 440 generates a control signal for at least some of the plurality of lights 460 to output light using the determined state. At step 550, the nozzle driver 430 generates a control signal for at least some of the plurality of nozzles 450 to change a spray mode using the determined state.

At step 510, the control unit 200 determines a first condition corresponding to a showerhead 100. The control unit 200 may determine the first condition based on data from the control unit outputted from the showerhead 100, etc. The control unit 200 may determine the condition based on programmed data within the control unit 200. By way of example, the control unit 200 may receive a command corresponding to a specific pre-programmed command (e.g., first programmed command, second programmed command, third programmed command, etc.), where the control unit 200 determines the first condition based on the desired programmed command.

At step 520, the light system 440 determines a state for a plurality of lights 460 of the showerhead 100 based on the first condition (e.g., determined at step 510). The light system 440 may cross-reference the conditions with data stored in memory 442. For instance, memory 442 may include a table including various conditions or ranges of conditions and corresponding states of the lights 460. For instance, the table may include various colors for which the lights 460 are to output light. The light system 440 may use data from the control unit 200 to perform a look-up function in the table to determine a corresponding color for the programmed command outputted from the control unit 200 of the showerhead 100. As another example, the table may include various warmth transitions for which the lights 460 are to output light and corresponding times of day.

At step 530, the nozzle driver 430 determines a state for a plurality of nozzles 450 of the showerhead 100 based on the first condition (e.g., determined at step 510). The nozzle driver 430 may cross-reference the conditions with data stored in the nozzle driver 430. For instance, the nozzle driver 430 may include a table including various conditions or ranges of conditions and corresponding states of the nozzles 450. For instance, the table may include various spray modes for which the nozzles 450 are to output water based on the programmed command from the control unit 200. The nozzle driver 430 may use data from the control unit 200 to perform a look-up function in the table to determine a corresponding spray mode for the programmed command outputted from the control unit 200 of the showerhead 100. As another example, the table may include various spray mode transitions for which the nozzles 450 are to change spray modes.

At step 540, the light system 440 generates a control signal for at least some of the plurality of lights 460 to output light using the determined state (e.g., determined at step 520). The light system 440 may generate a control signal to cause the lights 460 to output light according to the state. The light system 440 may transmit the control signal to the lights 460 to cause the lights 460 to turn on or off, to change a warmth of the white light, to change a color of the light, etc. based upon the programmed command. For example, the programmed command may correlate to a first programmed light command, where the lights 460 receive a command in coordination with the first programmed light command (e.g., first light mode for three seconds, second light mode for seven seconds, etc.).

In some embodiments, the light system 440 may determine a state of the lights 460 (e.g., at step 520) and generate control signals for the lights 460 (e.g., at step 540) to output light based on various combinations of the condition detected at step 510. For instance, the light system 440 may determine both a color (or warmth) for the lights 460 based on the programmed command. The light system 440 may generate a control signal that causes the lights 460 to output light having the determined color or warmth to convey a pre-programmed time constraint and to provide ambient lighting conditions in the shower space. Similarly, the light system 440 may determine both a color or warmth for the lights 460 based on the pre-programmed time constraint.

In some embodiments, the light system 440 may determine a series of states for the lights 460 based on the conditions. For instance, when the showerhead 100 is turned on, the light system 440 may determine a first state for the lights 460 based on the programmed command. The light system 440 may generate a control signal for the lights 460 to cause the lights 460 to output light having a color which changes with the pre-programmed command (e.g., blue to green to yellow to orange to red as the water temperature increases, for instance). Hence, the first state may be a particular color or color spectrum.

At step 550, the nozzle driver 430 generates a control signal for at least some of the plurality of nozzles 450 to change spray mode using the determined state (e.g., determined at step 530). The nozzle driver 430 may generate a control signal to cause the nozzles 450 to change spray mode according to the state. The nozzle driver 430 may transmit the control signal to the nozzles 450 to cause the nozzles 450 to turn on or off to ultimately change the spray mode based upon the programmed command. For example, the programmed command may correlate to a first programmed spray mode command, where the nozzles 450 receive a command in coordination with the first programmed spray mode command (e.g., first spray mode for three seconds, second spray mode for seven seconds, etc.).

In some embodiments, the nozzle driver 430 may determine a state of the nozzles 450 (e.g., at step 530) and generate control signals for the nozzles 450 (e.g., at step 550) to change spray mode based on various combinations of the condition detected at step 510. For instance, the nozzle driver 430 may determine one or more spray modes for the nozzles 450 based on the pre-programmed command. The nozzle driver 430 may generate a control signal that causes the nozzles 450 to change spray mode having a similar style to convey a pre-programmed time constraint and to provide an enjoyable shower experience.

In some embodiments, the nozzle driver 430 may determine a series of states for the nozzles 450 based on the conditions. For instance, when the showerhead 100 is turned on, the nozzle driver 430 may determine a first state for the nozzles 450 based on the pre-programmed time constraint. The nozzle driver 430 may generate a control signal for the nozzles 450 to cause the nozzles 450 to change spray mode having a first spray mode which changes with the pre-programmed command (e.g., first spray mode to second spray mode, combination of multiple spray modes to third spray mode, for instance). Hence, the first state may be a spray mode or combination of spray modes.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components (such as the light driver) used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the cord management system as shown in the various exemplary embodiments is illustrative only. Additionally, any element disclosed in one embodiment may be incorporated or utilized with any other embodiment disclosed herein. For example, the showerhead of the exemplary embodiment shown in FIGS. 1-6 may be incorporated in the other exemplary embodiments to provide different aesthetic features. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A showerhead comprising:
a first spray mechanism comprising a first plurality of nozzles and at least one lighting element;
a second spray mechanism separate from and located a distance away from the first spray mechanism; and
a surrounding structure comprising a plurality of members extending between the first spray mechanism and the second spray mechanism such that the first spray mechanism is at least partially surrounded by the surrounding structure.

2. The showerhead of claim 1, wherein the plurality of members are a plurality of removable fins providing at least a portion of an overall exterior shape for the showerhead.

3. The showerhead of claim 1, wherein the second spray mechanism has a ring shape and includes a second plurality of nozzles.

4. The showerhead of claim 1, wherein the first spray mechanism and the second spray mechanism are configured to emit water concurrently.

5. The showerhead of claim 1, wherein the first spray mechanism includes a diffuser for diffusing light from the at least one lighting element.

6. The showerhead of claim 1, wherein the second spray mechanism includes at least one lighting element and a diffuser for diffusing light from the at least one lighting element.

7. The showerhead of claim 1, wherein the plurality of members are radially oriented with respect to a central longitudinal axis of the showerhead and are spaced apart from each other.

8. The showerhead of claim 1, further comprising a speaker and a control unit, wherein the control unit is configured to control the at least one lighting element, the speaker, and a flow of water through the nozzles.

9. The showerhead of claim 8, wherein the control unit is configured to store programs for emitting light, sound, and water.

10. The showerhead of claim 8, wherein the control unit is configured to receive a command from at least one of a controller and a digital device.

11. The showerhead of claim 1, further comprising a hydro-generator.

12. A shower assembly comprising:
a first sprayhead;
a second sprayhead separate from the first sprayhead;
a plurality of replaceable fins extending between the first and second sprayhead and defining a structure that at least partially surrounds the first sprayhead;
at least one lighting element; and
at least one speaker.

13. The shower assembly of claim 12, wherein the shower assembly is configured to hang from a ceiling.

14. The shower assembly of claim 12, wherein the first sprayhead and the second sprayhead are configured to emit water concurrently.

15. The shower assembly of claim 12, wherein the plurality of replaceable fins are oriented radially with respect to a central longitudinal axis of the shower assembly.

16. The shower assembly of claim 12, wherein the plurality of replaceable fins include features configured to allow selective coupling of the replaceable fins to components of the showerhead.

17. The shower assembly of claim 12, further comprising a control unit configured to store programs for the emission of light, sound, and water from the shower assembly.

18. The shower assembly of claim 17, wherein the control unit is configured to receive a command from an electronic device.

19. The shower assembly of claim 12, further comprising a hydro-generator.

20. A method of assembling a showerhead, the method comprising:
placing a first shade mount and a second shade mount onto a jig;
inserting a covering panel into the first shade mount by rolling a first end of the covering panel into a slot in the first shade mount;
inserting a covering panel into the second shade mount by inserting a second end of the covering panel into a slot in the second shade mount;
inserting a plurality of covering panels into the first shade mount and the second shade mount to form the overall shape of the showerhead; and
fastening an upper portion of the second shade mount to a lower portion of the second shade mount using a fastener.
